(19) United States
(12) Patent Application Publication
(10) Pub. No.: US 2015/0142902 A1
(43) Pub. Date: May 21, 2015

(54) MANAGEMENT APPARATUS AND METHOD FOR CONTROLLING MANAGEMENT APPARATUS

(71) Applicant: FURYU CORPORATION, TOKYO (JP)

(72) Inventors: Kentaro SHIRAI, Tokyo (JP); Masahito ENOMOTO, Tokyo (JP); Nagisa IKEGAMI, Tokyo (JP); Taemi NAGAO, Tokyo (JP); Chiaki SHINZATO, Tokyo (JP); Juri KOMIYAMA, Tokyo (JP); Yoshiko TAKEMURA, Tokyo (JP)

(21) Appl. No.: 14/522,781

(22) Filed: Oct. 24, 2014

(30) Foreign Application Priority Data
Nov. 1, 2013 (JP) 2013-228700
Sep. 25, 2014 (JP) 2014-195810

(51) Int. Cl. H04L 12/58

(52) U.S. Cl. CPC H04L 51/08; H04L 51/22
USPC 709/206

(57) ABSTRACT

To prevent a user who has not yet saved content non-temporarily from forgetting to save the content in such a non-temporary manner, the present invention determines a remaining save period for temporarily saved content and save state of the content, and in the case where it has determined that (i) the remaining save period for the content is shorter than a predetermined period and (ii) the content has not yet been saved in a user dedicated storage area, transmits to an email address associated with the content an email for notification of the save state of the content.

This nonprovisional application claims priority under 35 U.S.C. §119 on patent application No. 2013-228700 filed in Japan on Nov. 1, 2013 and patent application No. 2014-195810 filed in Japan on Sep. 25, 2014, the entire contents of which are hereby incorporated by reference.

### TECHNICAL FIELD

The present invention relates to (i) a management apparatus for managing content by storing the content in association with an email address, (ii) an email transmission system including the management apparatus, and (iii) a method for controlling the management apparatus.

### BACKGROUND ART

There has been a service of providing a photograph sticker for a user who has played a game with a photograph sticker creating apparatus and additionally sending data on a photograph image to a communication terminal of the user.

Such a photograph image is sent to a communication terminal of a user typically through the following procedure:

A photograph sticker creating apparatus accepts an input of an email address from a user, and transmits the email address and a photograph image to a server.

Upon receipt of the email address entered by the user and the photograph image, the server stores the photograph image, and transmits to the email address an email for notification that the photograph image has been received by the server. To prevent the server from having a capacity shortage due to an increase of data on photograph images accumulated on the server, the photograph image is erased after it is saved for a fixed period.

The notification email transmitted by the server includes a URL. In the case where the user accesses the resource indicated by that URL on a communication terminal, a thumbnail of the photograph image is displayed on the communication terminal. If the user is a registered member, the user can select the thumbnail to display the photograph image with high resolution and save the photograph image in a storage area dedicated to the user (including a storage area on the user's communication terminal) which storage area is other than the storage area in which the photograph image is saved for the fixed period as described above.

A photograph image temporarily saved on the server is, as described above, erased after it is saved for the fixed period.

This means that if the user forgets to save a photograph image within the fixed period in a user dedicated storage area, that photograph image is deleted from the server, with the unfortunate result that the user can no longer view the photograph image.

Regarding the above point, Patent Literature 1 discloses a program and system for processing an expired object that are arranged to allow automation of (i) management of time limits for saving objects and (ii) processing performed in the case where such a time limit for saving an object has been reached. The program and system, with this arrangement, intend to delete only an object that is truly unnecessary for the operator.

Specifically, the system disclosed in Patent Literature 1 has (i) an attribute storing function of storing, as attributes of an object, the ID of the object, the registration location to which the object has been registered, the time limit for saving the object, and a rule about processing performed in the case where the time limit for saving the object has been reached and (ii) an expiration processing function of processing the object under the above rule in the case where the time limit for saving the object (the time limit having been stored with use of the attribute storing function) has been reached.

### CITATION LIST

Patent Literature 1

Japanese Patent Application Publication, Tokukai, No. 2007-109115 A (Publication Date: Apr. 28, 2007)

### SUMMARY OF INVENTION

### Technical Problem

Patent Literature 1 further discloses informing the operator under the rule by, for example, email that the time limit for saving the object has been reached.

Conventional techniques such as the above are arranged to, when the time limit for saving an object has been reached, inform the operator to that effect. Thus, if, for instance, a conventional technique such as the above is used for a server that saves photograph images, it will be impossible to transmit an email to the user before the time limit for saving a photograph image is reached. In other words, it will be problematically impossible to prevent the user from forgetting to save the photograph image in a non-temporary manner.

The present invention has been accomplished to solve the above problem. It is an object of the present invention to provide a management apparatus, an email transmission system, and a method for controlling a management apparatus each of which can prevent a user who has not yet saved content such as a photograph image non-temporarily from forgetting to save the content in such a non-temporary manner.

### Solution to Problem

In order to solve the above problem, a management apparatus of the present invention is a management apparatus including: a receiving section for receiving (i) content, which is a photograph image, created by a content providing apparatus and (ii) an email address entered at the content providing apparatus and associated with the content; a performing section for temporarily saving the content and the email address in association with each other in a temporary saving section; a remaining save period determining section for determining whether the content in the temporary saving section has a remaining save period shorter than a predetermined period; a save state determining section for determining whether the content has already been saved in a user dedicated storage area; and a transmitting section for, in a case where (i) the remaining save period determining section has determined that the remaining save period of the content is shorter than the predetermined period and (ii) the save state determining section has determined that the content has not yet been saved in the user dedicated storage area, transmitting to the email address an email for notification of a save state of the content.

In order to solve the above problem, a method of the present invention for controlling a management apparatus is a method for controlling a management apparatus, the method including: a receiving step for receiving (i) content, which is a photograph image, created by a content providing apparatus and (ii) an email address entered at the content providing apparatus and associated with the content; a performing step for temporarily saving the content and the email address in association with each other in a temporary saving section; a remaining save period determining step for determining whether the content in the temporary saving section has a remaining save period shorter than a predetermined period; a save state determining step for determining whether the content has already been saved in a user dedicated storage area; and a transmitting step for, in a case where (i) the remaining save period determining step has determined that the remaining save period of the content is shorter than the predetermined period and (ii) the save state determining step has determined that the content has not yet been saved in the user dedicated storage area, transmitting to the email address an email for notification of a save state of the content.

The above arrangement allows an email for notification of the save state of content to be transmitted to an email address, associated with content not yet saved in a user dedicated storage area, before the time point at which the temporary saving of the content ends. The above arrangement thus allows the user to learn that the content not yet saved in a user dedicated storage area has only a short period before the time limit for the temporary saving in the temporary saving section. The above arrangement can, as the result, prevent the user from forgetting to save, in a user dedicated storage area, content that has not yet been saved in such a dedicated storage area.

### Advantageous Effects of Invention

A mode of the present invention can advantageously prevent a user, who has not yet saved content in a user dedicated storage area, from forgetting to save the content in such a dedicated storage area.

### BRIEF DESCRIPTION OF DRAWINGS

FIG. 1 is a block diagram illustrating a main part of a management server of Embodiment 1 of the present invention.

FIG. 2 is a diagram schematically illustrating a main part of an email transmission system of Embodiment 1 of the present invention.

FIG. 3 is a perspective view of a photograph sticker creating apparatus of Embodiment 1 of the present invention, the view showing an example exterior of the photograph sticker creating apparatus.

FIG. 4 is a block diagram illustrating a main part of a photograph sticker creating apparatus of Embodiment 1 of the present invention.

FIG. 5 is a block diagram illustrating a main part of a portable terminal of Embodiment 1 of the present invention.

FIG. 6 is a sequence diagram illustrating an example flow of an email transmission process of Embodiment 1 of the present invention.

FIG. 7 illustrates example screens displayed at a photograph sticker creating apparatus of Embodiment 1 of the present invention, where (a) is a diagram illustrating an example display screen for a user to select an image, and (b) is a diagram illustrating an example display screen for a user to enter an email address.

FIG. 8 is a flowchart illustrating an example flow of an expiration alert process of Embodiment 1.

FIG. 9 is a flowchart illustrating an example flow of a member status-specific notification email transmission process of Embodiment 1.

(a) to (d) of FIG. 10 show an example of transition of screens displayed by a display section of a portable terminal of Embodiment 1.

(a) and (b) FIG. 11 show another example of transition of screens displayed by a display section of a portable terminal of Embodiment 1.

(a) and (b) of FIG. 12 show a still another example of transition of screens displayed by a display section of a portable terminal of Embodiment 1.

FIG. 13 is a diagram illustrating an example image displayed by a display section of a portable terminal of Variation 1.

FIG. 14 is a flowchart illustrating an example flow of an expiration alert process of Variation 2.

FIG. 15 is a flowchart illustrating an example flow of an expiration alert process of Variation 3.

FIG. 16 is a flowchart illustrating an example flow of an expiration alert process of Variation 4.

FIG. 17 is a flowchart illustrating an example flow of an expiration alert process of Variation 5.

FIG. 18 is a block diagram illustrating a main part of a management server of Variation 6.

FIG. 19 is a flowchart illustrating an example flow of a billing amount deciding process of Variation 6.

### DESCRIPTION OF EMBODIMENTS

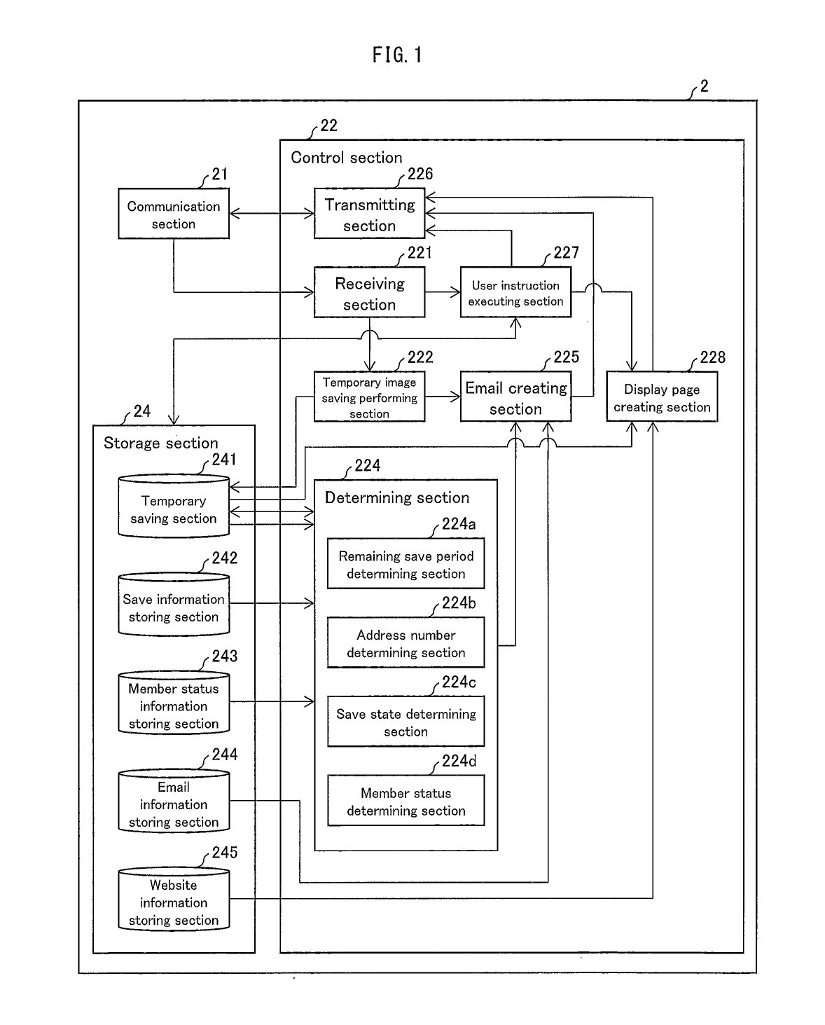

An embodiment of the present invention is described below with reference to FIGS. 1 through 17. The description below deals with a main part of the arrangement of the specific embodiment, so the other part is not described. In the case where such other part of the arrangement is described for any other embodiment (variation), it is as so described. Further, for convenience of explanation, any member having a function identical among different embodiments is assigned a common reference sign, and a description of such a member is omitted as appropriate. The shapes and dimensions (length, width, and depth) of the individual members illustrated in the drawings do not reflect the actual shapes and dimensions, and are changed as appropriate for clear and simple illustrations.

### Embodiment 1

With reference to FIGS. 1 through 12, the description below deals in detail with, as example modes of a management apparatus, content providing apparatus, communication terminal, and email transmission system of the present invention, (i) a management server (management apparatus) 2, (ii) a photograph sticker creating apparatus (content providing apparatus) 4, (iii) a portable terminal (communication terminal) 3, and an email transmission system 1. The term “content” as used to describe the present embodiment refers to data on a photograph taken with use of the photograph sticker creating apparatus 4 (that is, a photograph image or photograph image data). Note that the management apparatus, content providing apparatus, communication terminal, and email transmission system of the present invention are not limited to the modes described below. For example, the communication terminal is not limited to a portable terminal such as a mobile telephone, a smartphone, and a tablet terminal, and may be a communication terminal such as a desktop or notebook PC.

(Email Transmission System 1)

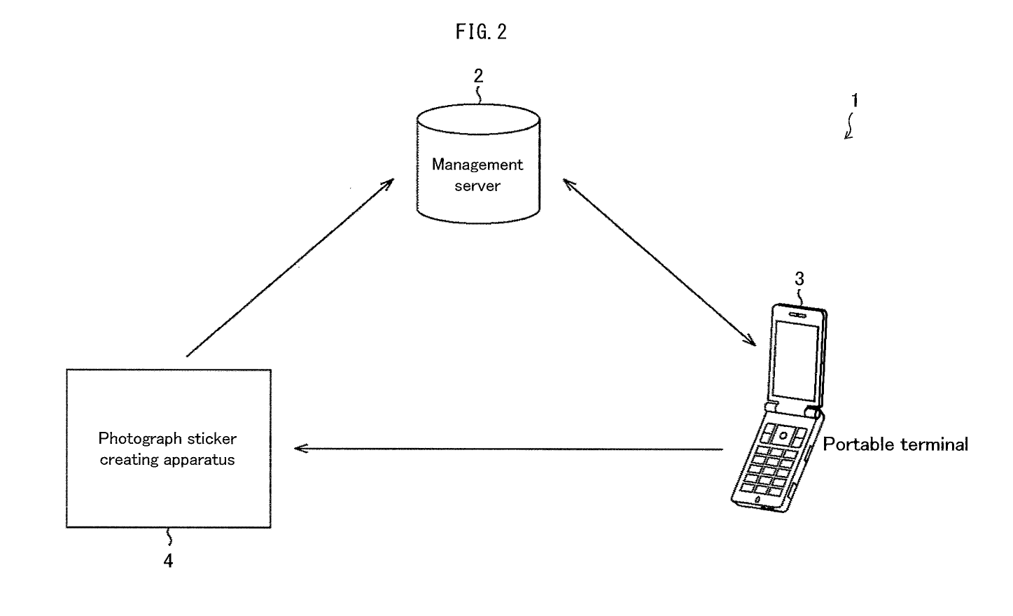

FIG. 2 is a diagram schematically illustrating a main part of the email transmission system 1 of Embodiment 1 of the present invention. The email transmission system 1, as illustrated in FIG. 2, includes a management server 2, a photograph sticker creating apparatus 4, and a portable terminal 3.

The email transmission system 1 is outlined as follows: First, a user enters an email address into the photograph sticker creating apparatus 4 to receive, at the portable terminal 3, a photograph image created at the photograph sticker creating apparatus 4. The photograph sticker creating apparatus 4 then transmits, to the management server 2, the photograph image (photograph image data) as well as the email address and photograph image information (content identification information; information for identifying the photograph image) both associated with the photograph image. The user may enter a plurality of email addresses into the photograph sticker creating apparatus 4, in which case the photograph sticker creating apparatus 4 transmits, to the management server 2, the photograph image as well as such a plurality of email addresses and photograph image information both associated with the photograph image. In the case where the user has entered no email address, the photograph sticker creating apparatus 4 transmits, to the management server 2, the photograph image and photograph image information associated with the photograph image.

The term “photograph image” refers not only to the image of a photograph taken with use of the photograph sticker creating apparatus 4, but also to an image as edited of a photograph taken with use of the photograph sticker creating apparatus 4. Further, the “photograph image information” is, for example, the name of an image file or an ID assigned to the image (sticker ID described below). The photograph sticker creating apparatus 4 may alternatively transmit other information to the management server 2 together with the photograph image.

The present embodiment described herein is arranged such that the photograph sticker creating apparatus 4 transmits a sticker ID to the management server 2 as the photograph image information. In the present embodiment, the sticker ID refers to identification information indicative of one or more photograph images created by the photograph sticker creating apparatus 4 in a single play (game). The photograph sticker creating apparatus 4, in this case, associates the email address, entered by the user, with a sticker ID indicative of one or more photograph images created in a single play. The photograph sticker creating apparatus 4 then transmits, to the management server 2, (i) the one or more photograph images created in a single play, (ii) the sticker ID indicative of the one or more photograph images, and (iii) the email address associated with the sticker ID.

Upon receipt of the email address, the management server 2 transmits, to the email address, an email including (i) a URL (content obtaining information) of a web page for obtaining one or more photograph images associated with the email address or (ii) a display image (thumbnail of the photograph image) having a hyperlink with that web page. The user receives the email at the portable terminal 3, and operates the portable terminal 3 to select (press) the URL or link for access to the web page. In response to the user's request to access the web page (content obtaining request), the management server 2 transmits, to the portable terminal 3, the web page for obtaining or saving the photograph image.

To prevent the management server 2 from having a capacity shortage due to an increase of data on photograph images accumulated on the management server 2, the management server 2, after receiving the photograph image from the photograph sticker creating apparatus 4, erases the received photograph image after saving the photograph image for a fixed period. This means that to view a photograph image after the fixed period, the user needs to save the photograph image in a storage area other than a temporary saving section 241, in which the management server 2 saves a photograph image for the fixed period.

The management server 2 of Embodiment 1 of the present invention determines whether a photograph image temporarily saved in the temporary saving section 241 (which is included in the management server 2 for saving a photograph image for a fixed period) has a remaining save period shorter than a predetermined period. The remaining save period for a photograph image refers to a remaining period for which that photograph image will be saved in the temporary saving section 241, in other words, a period remaining before the photograph image is erased from the temporary saving section 241.

Next, the management server 2 determines whether a photograph image stored in the temporary saving section 241 for over a certain period has already been saved in a storage area other than the temporary saving section 241 (which is included in the management server 2 for temporarily saving photograph images).

In the case where the management server 2 has determined that the photograph image has a remaining save period shorter than the predetermined period and that the photograph image has not yet been saved in a storage area other than the temporary saving section 241, the management server 2 transmits, to the email address associated with the photograph image, an email for notification that the photograph image has not yet been saved in a storage area other than the temporary saving section 241.

The present embodiment can, with the above arrangement, prevent the user, who has not yet saved a photograph image in a storage area other than the temporary saving section 241, from forgetting to save that photograph image in such another storage area within a fixed period.

(Management Server 2)

The description below deals with the management server 2 with reference to FIG. 1. FIG. 1 is a block diagram illustrating a main part of the management server 2 of Embodiment 1 of the present invention. The management server 2, as illustrated in FIG. 1, includes a communication section 21, a control section 22, and a storage section 24. The control section 22 includes a receiving section 221, a temporary image saving performing section 222, a determining section 224, an email creating section 225, a transmitting section 226, a user instruction executing section 227, and a display page creating section 228.

(Communication Section 21)

The communication section 21 includes a communication device for communicating with the photograph sticker creating apparatus 4 and the portable terminal 3. Specifically, the communication section 21 receives, from the photograph sticker creating apparatus 4, a photograph image, the sticker ID of the photograph image, and an email address entered by a user, and outputs such received data to the receiving section 221 described below. The communication section 21 also transmits, to the email address entered by the user, an email created by the email creating section 225 described below. Further, the communication section 21 transmits, to the portable terminal 3, individual web pages of an image providing website.

(Receiving Section 221)

The receiving section (receiving means) 221 receives, from the communication section 21, various information items received by the communication section 21 from the photograph sticker creating apparatus 4 and the portable terminal 3, and outputs such received information to different sections. The receiving section 221 receives, for example, a photograph image, the sticker ID of the photograph image, and an email address entered by a user, and outputs such received information to the temporary image saving performing section 222. The receiving section 221 also receives information indicating that a URL (or a hyperlinked display image) included in an email transmitted to the email address entered by the user has been selected on the portable terminal 3, and outputs such received information to the user instruction executing section 227.

The receiving section 221 further outputs, to the user instruction executing section 227, an instruction entered by the user on the portable terminal 3 to save a photograph image in a storage area other than the temporary saving section 241.

(Temporary Image Saving Performing Section 222)

The temporary image saving performing section (performing section, temporary saving performing means) 222 receives a photograph image, a sticker ID, and an email address from the receiving section 221, and stores the photograph image, the sticker ID (photograph image information), and the email address in the temporary saving section 241. Specifically, the temporary image saving performing section 222 stores, in the temporary saving section 241 in association with one another, (i) one or more photograph images created in a single play, (ii) a sticker ID indicative of the one or more photograph images, and (iii) an email address associated with the sticker ID. Further, the temporary image saving performing section 222 outputs, to the email creating section 225, the email address and the sticker ID both associated with the photograph image stored.

The temporary image saving performing section 222 may alternatively determine, when receiving a photograph image, whether it has received any email address associated with that photograph image is. The temporary image saving performing section 222 may be arranged to, in the case where it has determined that it has received no email address associated with the photograph image, not store the photograph image received.

(Determining Section 224)

The determining section 224 includes a remaining save period determining section (remaining save period determining means) 224a, an address number determining section 224b, a save state determining section (save state determining means) 224c, and a member status determining section 224d.

(Remaining Save Period Determining Section 224a)

The remaining save period determining section 224a determines whether a photograph image stored in the temporary saving section 241 has a remaining save period shorter than a period extending from (i) the time point at which a temporary save period for that photograph image ends to (ii) a predetermined time point set to come before the time point at which the temporary save period ends. The remaining save period determining section 224a, in other words, determines whether a photograph image stored in the temporary saving section 241 has a remaining save period shorter than a predetermined period. The remaining save period determining section 224a, in the case where it has determined that the photograph image has a remaining save period shorter than the predetermined period, outputs the sticker ID associated with that photograph image to the save state determining section 224c.

Specifically, the present embodiment is arranged, for instance, such that a photograph image is deleted from the temporary saving section 241 one week after the start of temporary saving of the photograph image in the temporary saving section 241. The remaining save period determining section 224a sets the predetermined time point to two days before the time point at which the temporary saving ends (at which the photograph image is deleted from the temporary saving section 241), that is, five days after the temporary saving starts. The remaining save period determining section 224a, in other words, determines whether a photograph image has a remaining save period shorter than two days.

For instance, the remaining save period determining section 224a may, (i) when a photograph image is saved in the temporary saving section 241, calculate a time point that is a predetermined period before the time point at which the temporary saving ends (in the case where the management server 2 is arranged such that a photograph image is deleted one week after the start of its temporary saving and the predetermined period is two days, the calculated time point will be five days after the start of the temporary saving) and (ii) save the calculated time point in association with the photograph image. The remaining save period determining section 224a may alternatively determine whether the current time is past the calculated time point.

The remaining save period determining section 224a may further output, to the address number determining section 224b, the sticker ID associated with a photograph image having a remaining save period shorter than the predetermined period (two days).

(Address Number Determining Section 224b)

The address number determining section 224b determines whether the number of email addresses entered for a sticker ID is two or more, and outputs the result of the determination and the sticker ID to the save state determining section 224c.

Specifically, the address number determining section 224b may, for instance, detect data on the email address(es), saved in the temporary saving section 241 in association with the sticker ID, to determine the number of email addresses.

(Save State Determining Section 224c)

The save state determining section 224c receives the sticker ID associated with a photograph image, and determines whether the user has already saved, non-temporarily in a user dedicated storage area, the photograph image with which the sticker ID is associated. The save state determining section 224c may, for instance, determine whether each photograph image indicated by a sticker ID has already been saved in a storage area dedicated to the user corresponding to the email address associated with the sticker ID.

The save state determining section 224c may, for instance, refer to save information described below to determine whether a photograph image has already been saved in a user dedicated storage area.

In the case where the save state determining section 224c has determined that the photograph image has not yet been saved in a user dedicated storage area, the save state determining section 224c obtains the email address associated with the photograph image from the temporary saving section 241, and outputs the email address to the member status determining section 224d.

In the case where the save state determining section 224c has received, from the address number determining section 224b, a result that two or more email addresses are associated with a photograph image indicated by a single sticker ID, the save state determining section 224c may determine whether the photograph image has already been saved by the user corresponding to at least one of the email addresses. In the case where the save state determining section 224c has determined that the photograph image has already been saved by the user corresponding to at least one of the email addresses, the save state determining section 224c may (i) not output, to the member status determining section 224d, the email addresses associated with the photograph image or (ii) output, to the member status determining section 224d, an email address(es) associated with the photograph image and corresponding to a user(s) other than the user who has already saved the photograph image.

(Member Status Determining Section 224d)

The member status determining section 224d performs a member status-specific notification email transmission process. Upon receipt of an email address from the save state determining section 224c, the member status determining section 224d refers to member status information in the member status information storing section 243 to determine whether the user corresponding to the email address received is a registered member or is a paid member (a registered member is either a free member or paid member).

The member status determining section 224d outputs, to the email creating section 225, an email address and member status information for the user corresponding to that email address (for example, information on the user being a non-member, a free member, or a paid member).

(Email Creating Section 225)

The email creating section 225 creates an email to be transmitted to an email address entered by the user. Specifically, the email creating section 225, upon receipt from the temporary image saving performing section 222 of an email address entered by the user, creates an email addressed to the email address entered by the user. This email includes (i) a URL of a web page for saving a temporarily saved photograph image in a user dedicated storage area or (ii) a display image having a hyperlink with that web page. The user can select the URL to save or download the photograph image to the dedicated storage area. The email creating section 225 obtains the URL of the web page from, for example, the display page creating section 228. The email creating section 225 outputs the email created to the transmitting section 226, and instructs the transmitting section 226 to cause the communication section 21 to transmit the email to the email address entered by the user.

The email creating section 225 also receives, from the determining section 224 (member status determining section 224d), (i) an email address(es) associated with a photograph image not yet saved in a user dedicated storage area and (ii) member status information for the user(s) corresponding to the email address(es). The email creating section 225 then refers to email information in an email information storing section 244 to create an email(s), customized to each member status, for notification that a photograph image has not yet been saved in a user dedicated storage area. The email creating section 225 outputs the email(s) created to the transmitting section 226, and instructs the transmitting section 226 to cause the communication section 21 to transmit the email(s) to the email address(es) entered by the user(s). The email creating section 225, in other words, creates emails for notification of the user(s) forgetting to non-temporarily save a photograph image which notification differs according to the member status (namely, a non-member, a free member, or a paid member).

(Transmitting Section 226)

The transmitting section (transmitting means) 226 causes the communication section 21 to transmit an email outputted from the email creating section 225 and a web page outputted from the display page creating section 228.

(User Instruction Executing Section 227)

The user instruction executing section (user instruction executing means) 227, upon receipt from the receiving section 221 of information indicating that a URL (or a hyperlinked display image) included in an email transmitted to an email address entered by the user has been selected on the portable terminal 3, instructs the display page creating section 228 to create a web page.

The user instruction executing section 227 also obtains, from the portable terminal 3 via the receiving section 221, an instruction to save, in a user dedicated storage area, a photograph image stored in the temporary saving section 241, and saves the photograph image as such. The user instruction executing section 227 may, for instance, instruct the transmitting section 226 to cause the communication section 21 to transmit, to the portable terminal 3, a photograph image temporarily saved in the temporary saving section 241. The user instruction executing section 227 may alternatively save a photograph image non-temporarily on an external server other than the management server 2. In such a case, the user instruction executing section 227 may similarly instruct the transmitting section 226 to cause the communication section 21 to transmit, to the external server, a photograph image stored in the temporary saving section 241. The present embodiment may alternatively be arranged such that the management server 2 includes a photograph image storage area other than the temporary saving section 241 and upon acceptance from the user of an instruction to save a photograph image non-temporarily, saves it in that other storage area.

The user instruction executing section 227 may, after saving a photograph image as described above, update save information (save history for photograph images) stored in a save information storing section 242. Save information may include information such as information on (i) a photograph image saved, (ii) the sticker ID indicative of the photograph image, (iii) the date and time the photograph image was saved, (iv) the location to which the photograph image was saved, (v) the user(s) who saved the photograph image (or an email address corresponding to that user), and (vi) any user among the users corresponding to the email addresses associated with the photograph image who has not yet saved the photograph image non-temporarily (or an email address corresponding to that user). Save information may be (i) created when a photograph image is temporarily saved in the temporary saving section 241 and then (ii) saved in the save information storing section 242.

(Display Page Creating Section 228)

The display page creating section 228 creates a web page to be displayed on the portable terminal 3. Specifically, the display page creating section 228, in response to an access request made at a website for providing images for the user and received by the receiving section 221, reads web page data from the website information storing section 245 and creates a web page to be displayed on the portable terminal 3. The display page creating section 228 may create a web page with use of, for example, user information stored in the member status information storing section 243 and/or a thumbnail image of a photograph image associated with user information.

The display page creating section 228 also creates a web page in accordance with an instruction from the determining section 224 (member status determining section 224d), and outputs the web page created to the transmitting section 226. The transmitting section 226 then causes the communication section 21 to transmit the outputted web page to the portable terminal 3.

(Storage Section 24)

The storage section 24 includes a temporary saving section 241, a save information storing section 242, a member status information storing section 243, an email information storing section 244, and a website information storing section 245.

(Temporary Saving Section 241)

The temporary saving section 241 is a memory for temporarily saving (i) a photograph image received from the photograph sticker creating apparatus 4, (ii) an email address entered, and (iii) a sticker ID in association with one another. The temporary saving section 241 of the present embodiment is arranged to delete a temporarily saved data one week after the start of the temporary saving. The temporary save period is, however, not limited in length to one week.

(Save Information Storing Section 242)

The save information storing section 242 is a memory for storing save information for photograph images stored in the temporary saving section 241.

(Member Status Information Storing Section 243)

The member status information storing section 243 is a memory for storing various items of information on a user as a member of an image providing website. The member status information storing section 243 may store such information items, in association with one another, as (i) a user ID for uniquely identifying a user, (ii) an email address of the user, (iii) an ID for identifying a portable terminal 3 used by the user, (iv) the member status for the user (for example, a paid member or a free member), and (v) a photograph image saved by the user. Information stored in the member status information storing section 243 is not limited to the above examples. The member status information storing section 243 may store other user information such as an account ID for identifying a user.

(Email Information Storing Section 244)

The email information storing section 244 is a memory for storing data on an email to be transmitted to the user.

(Website Information Storing Section 245)

The website information storing section 245 is a memory for storing data on web pages of an image providing website to be displayed on the portable terminal 3.

(Photograph Sticker Creating Apparatus 4)

The photograph sticker creating apparatus 4 is a game device that accepts money from the user to allow the user to (i) operate the game device to, for example, take a photograph and edit the photograph as part of a game and (ii) receive the photograph image or image edited. The photograph sticker creating apparatus 4 is installed at a store of a game arcade, for example. The photograph sticker creating apparatus 4 may be used by a single user or a plurality of users.

To play a game provided by the photograph sticker creating apparatus 4, the user (i) puts money into the photograph sticker creating apparatus 4, (ii) takes a photograph of the user as the subject, (iii) selects, from among the photograph images created through the photography operation, an image to be edited, and (iv) edits that photograph image with use of an edit function of decorating a photograph image with a handwritten line drawing and/or stamp image. This makes the photograph image more colorful. The user then receives a sticker sheet with the edited image printed on it, to end a series of game operations.

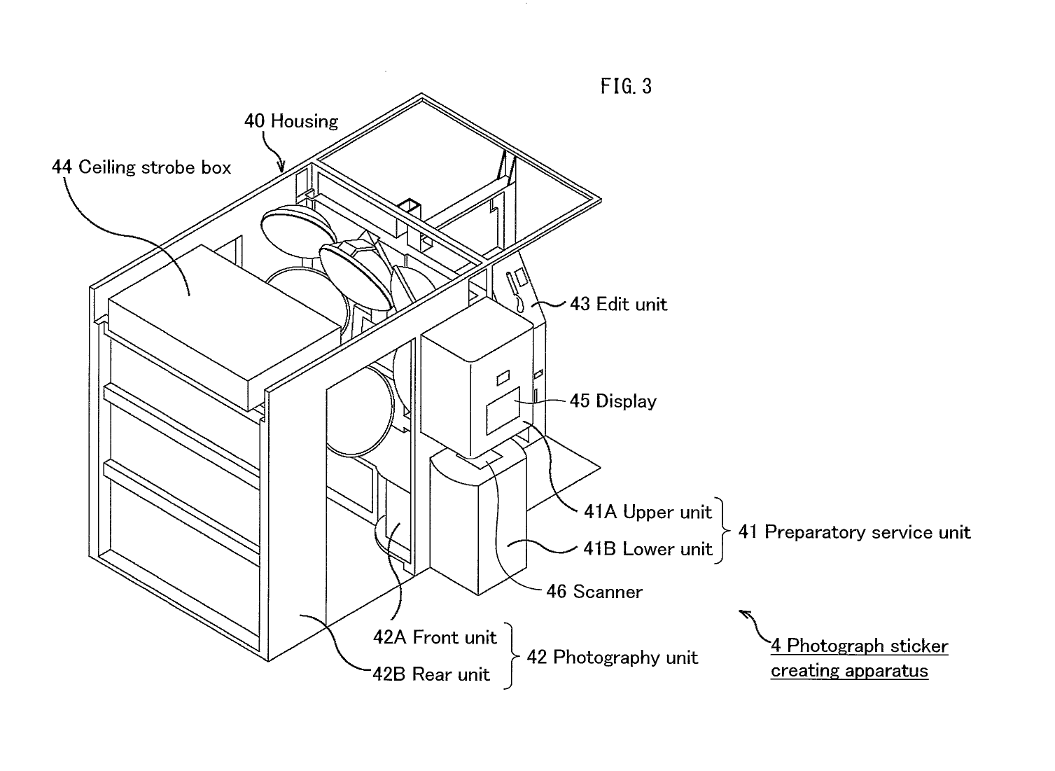

FIG. 3 is a perspective view of the photograph sticker creating apparatus 4 of Embodiment 1 of the present invention, the view showing an example exterior of the photograph sticker creating apparatus 4. The photograph sticker creating apparatus 4, as illustrated in FIG. 3, includes a housing 40, a preparatory service unit 41, a photography unit 42, an edit unit 43, a ceiling strobe box 44, a display 45, and a scanner 46. The preparatory service unit 41 includes an upper unit 41A and a lower unit 41B. The photography unit 42 includes a front unit 42A and a rear unit 42B. The display 45 is provided at the upper unit 41A, and the scanner 46 is provided at the lower unit 41B. The photograph sticker creating apparatus 4 is, however, simply required to be an apparatus capable of creating a photograph sticker, and is not limited in arrangement to the above example.

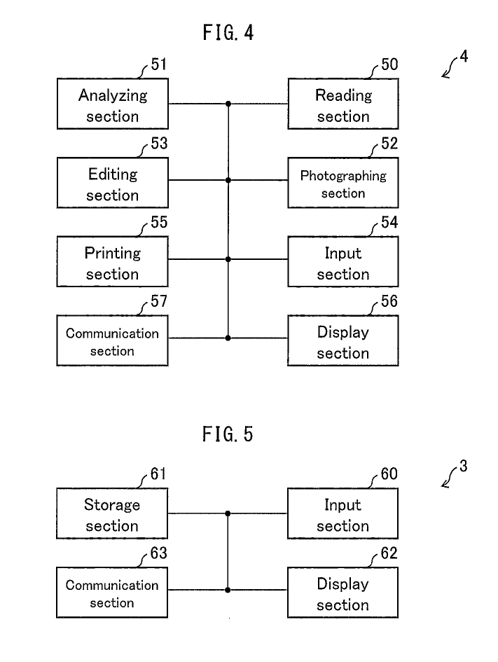

FIG. 4 is a block diagram illustrating a main part of the photograph sticker creating apparatus 4 of Embodiment 1 of the present invention. The photograph sticker creating apparatus 4, as illustrated in FIG. 4, includes a reading section 50, an analyzing section 51, a photographing section 52, an editing section 53, an input section 54, a printing section 55, a display section 56, and a communication section 57. The details of the individual sections of the photograph sticker creating apparatus 4 are not so relevant to the essence of the present invention, and are not described herein.

The display section 56 displays a screen that allows the user to (i) select a photograph image to be transmitted to the management server 2 and (ii) enter an email address.

(Portable Terminal 3)

The portable terminal 3 is carried by the user. The user saves a photograph image created at the photograph sticker creating apparatus 4 into one of the following storage sections through an image providing website: (i) a storage section that is included in the management server 2 and that is other than the temporary saving section 241, (ii) a storage section included in an external apparatus separate from the management server 2, and (iii) a storage section included in the portable terminal 3 of the user.

FIG. 5 is a block diagram illustrating a main part of the portable terminal 3 of Embodiment 1 of the present invention. The portable terminal 3, as illustrated in FIG. 5, includes an input section 60, a storage section 61, a display section 62, and a communication section 63. The display section 62 (display means) is a display device for displaying various images. The display section 62 displays, for example, an email or web page transmitted from the communication section 21 of the management server 2. The details of the other individual sections of the portable terminal 3 are not so relevant to the essence of the present invention, and are not described herein.

(Email Transmission Process)

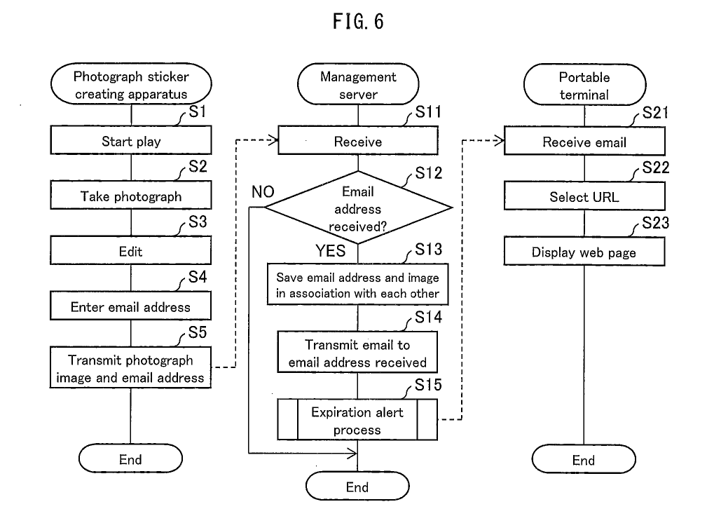

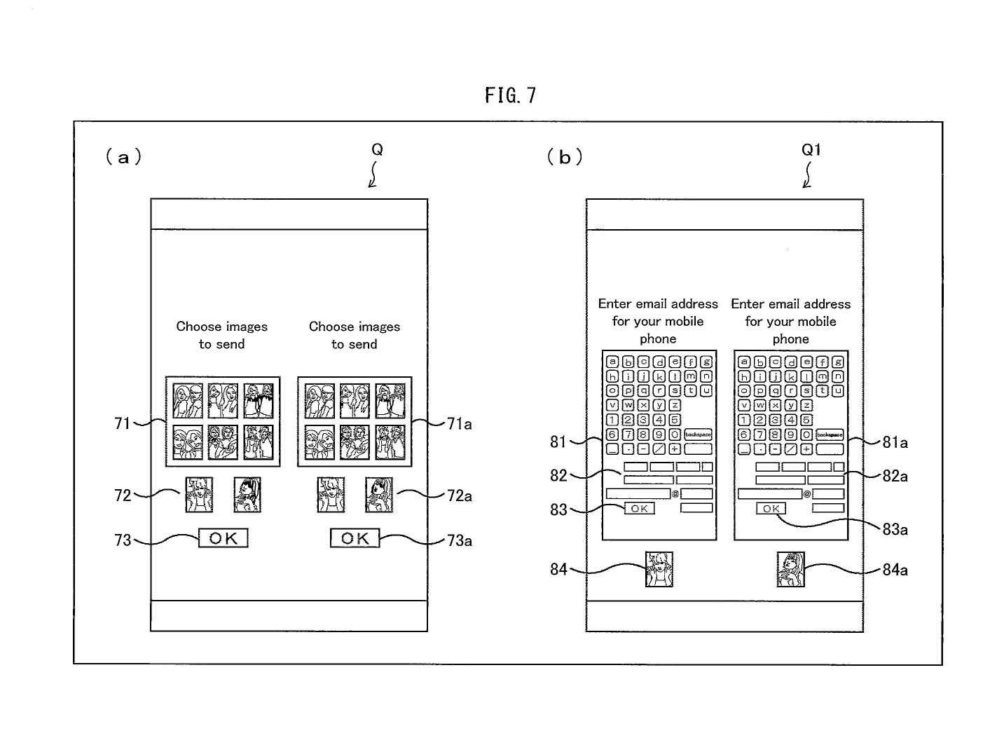

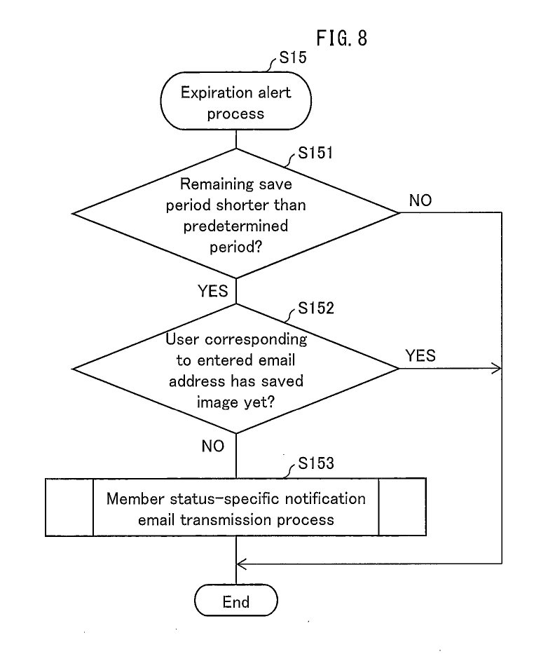

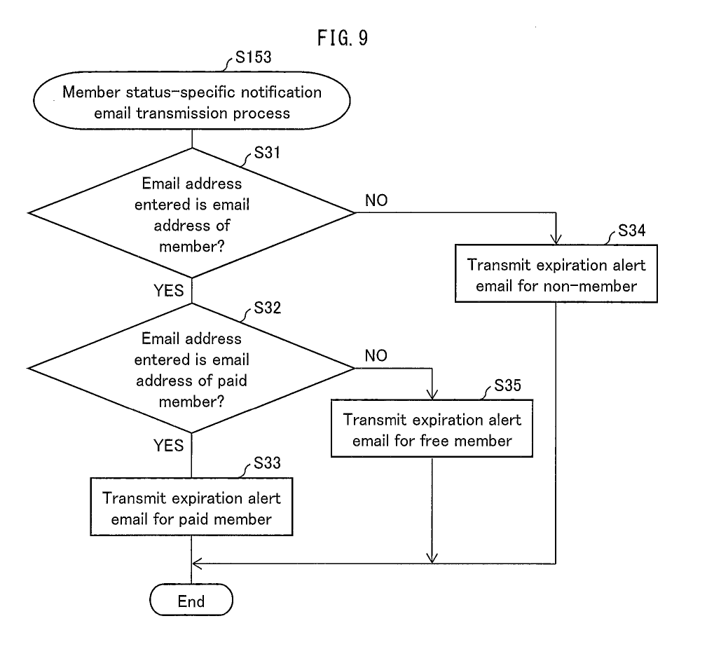

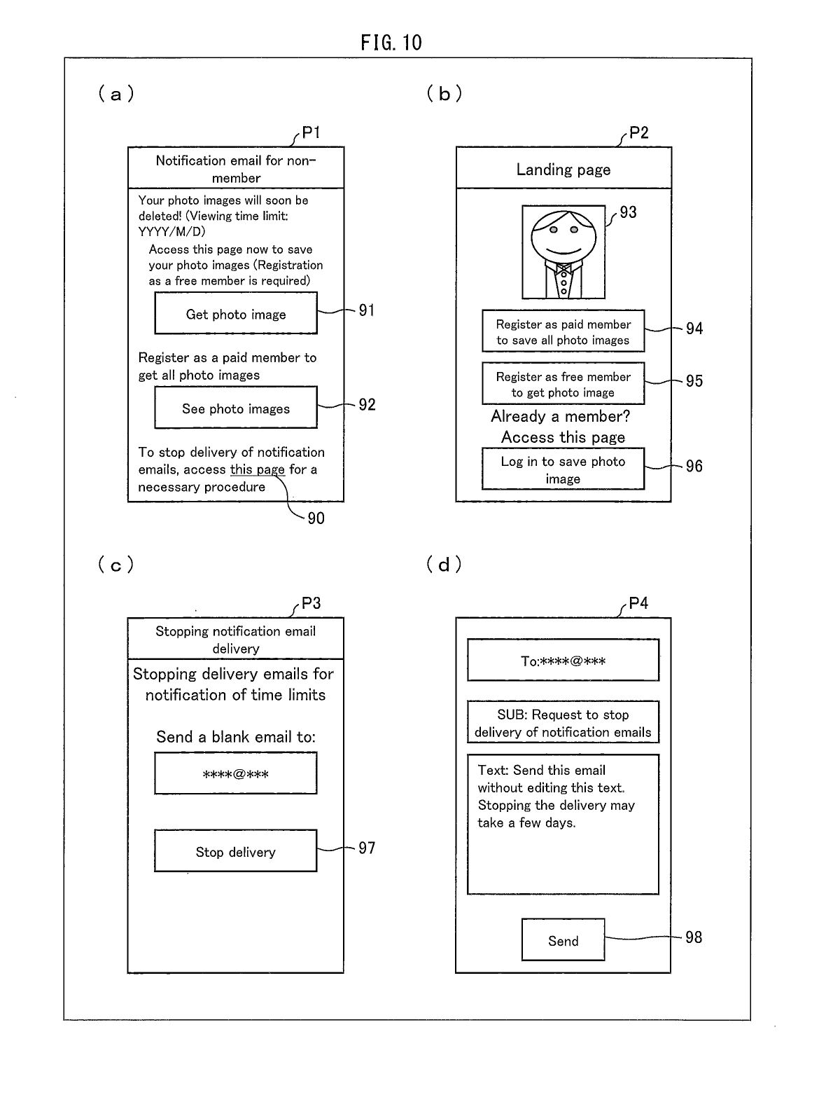

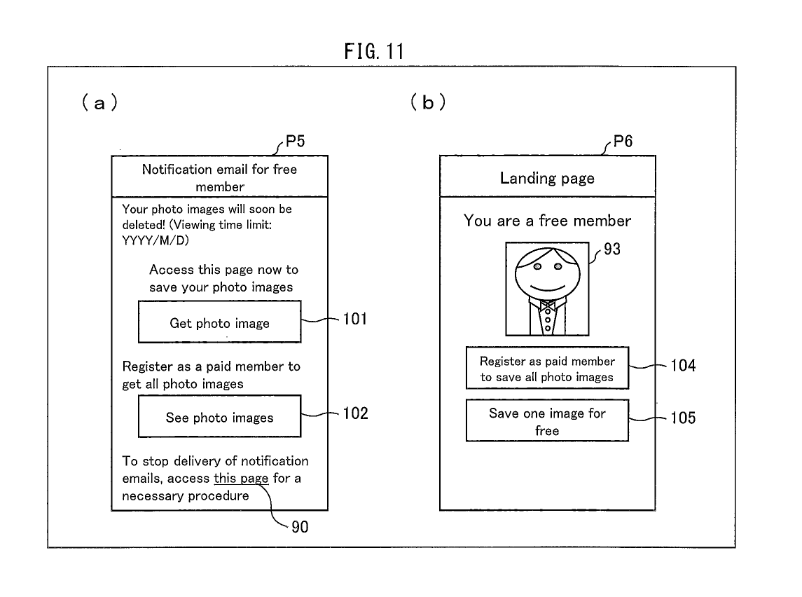

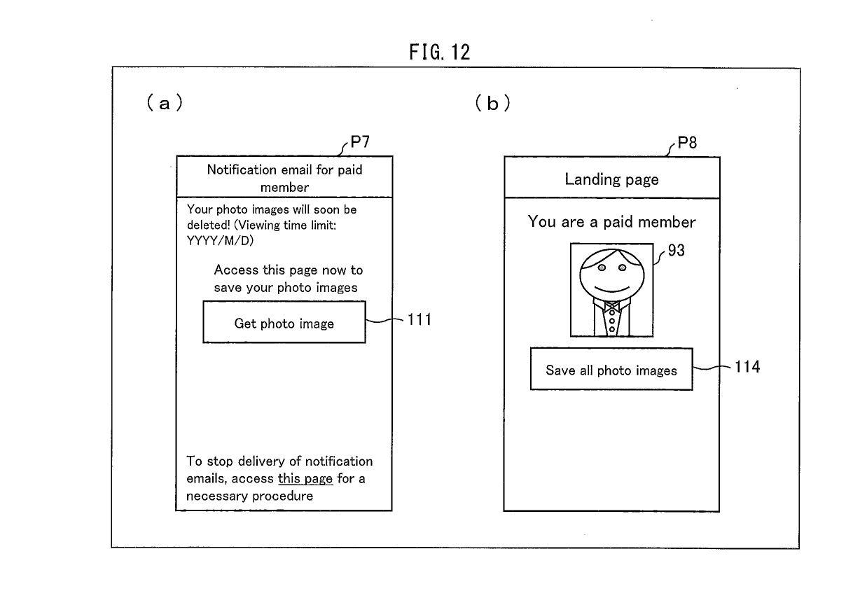

The description below deals in detail with an email transmission process with reference to FIGS. 6 through 12. FIG. 6 is a sequence diagram illustrating an example flow of the email transmission process of Embodiment 1 of the present invention. FIG. 7 illustrates display screens displayed at the photograph sticker creating apparatus 4 of Embodiment 1 of the present invention to allow the user to select an image and enter an email address. FIG. 8 is a flowchart illustrating an example flow of an expiration alert process of Embodiment 1. FIG. 9 is a flowchart illustrating an example flow of a member status-specific notification email transmission process of Embodiment 1. FIGS. 10 through 12 are each a diagram illustrating transition of screens displayed by the display section 62 of the portable terminal 3 of Embodiment 1 of the present invention.

First, as illustrated in FIG. 6, the user starts to play a game at the photograph sticker creating apparatus 4 (step S1). Specifically, the user stands in front of the preparatory service unit 41 of the photograph sticker creating apparatus 4 and puts money necessary to play a game into a coin slot (not shown). This allows the user to start to play a game.

Next, the photograph sticker creating apparatus 4 takes a photograph of the user (step S2). Specifically, the user enters the photography unit 42 and presses a photography button (not shown). The photographing section 52 of the photograph sticker creating apparatus 4, in response, causes the ceiling strobe box 44 to emit a flashlight and starts a process of taking a photograph of the user. This process causes an image sensing element (not shown) to send image sensing signals to the photographing section 52, which in turn creates photograph images of the user on the basis of that signal. The photographing section 52 then outputs the photograph images created to the display section 56.

Next, the photograph sticker creating apparatus 4 allows the user to edit the photograph images created (step S3). Specifically, the user stands in front of the edit unit 43. The display section 56 displays the photograph images on a display screen (not shown) provided at the edit unit 43. The user then edits the photograph images on the screen with use of a stylus or the like (not shown). In response, the editing section 53 of the photograph sticker creating apparatus 4 reflects, in the photograph image, the edition performed by the user on the screen.

When the user has finished editing the photograph images, the editing section 53 outputs, to the printing section 55 and the communication section 57, photograph images each of which reflects the edition. If the user presses a print button (not shown) after the edition is completed, the printing section 55 of the photograph sticker creating apparatus 4 controls a printer (not shown) so that the printer prints the user's photograph images onto a sticker sheet. The user can thereby obtain a photograph sticker.

After the image edition is finished, the display section 56 of the photograph sticker creating apparatus 4 displays, on the display screen (not shown) provided at the edit unit 43, an email address entry screen for entering an email address.

FIG. 7 illustrates example screens that simultaneously allow two users to each select an image and enter an email address.

(a) of FIG. 7 illustrates an example display screen Q that allows users to each select, from among photograph images created at the photograph sticker creating apparatus 4 in a single play, a photograph image to be transmitted to the management server 2.

(a) of FIG. 7 shows, at a substantially central portion of an image selection screen segment, an image option display region 71, in which the screen displays a plurality of photograph images for a user to select a photograph image from. (a) of FIG. 7 also shows, below the substantially central portion, an OK button 73 that the user presses to select a photograph image for transmission. (a) of FIG. 7 also shows, between the image option display region 71 and the OK button 73, a transmission image display region 72, in which the screen displays a photograph image to be transmitted.

The display screen Q shows a screen segment described above on its left half and a similar screen segment on the right half. Specifically, the display screen Q shows, to the right of the image option display region 71, the OK button 73, and the transmission image display region 72, a screen segment including an image option display region 71a, an OK button 73a, and a transmission image display region 72a.

The screen described above allows two users to each separately select an image to be transmitted to the user's portable terminal 3. The users may select their respective images at the same time or at different times. There is no limit to when such users select their respective images.

Further, an individual user may select a plurality of images for transmission.

(b) of FIG. 7 illustrates an example display screen Q1 that allows users to each enter an email address.

The display screen Q1 illustrated in (b) of FIG. 7 shows, on its left half, an alphabet display region 81, an image display region 84, an email address display region 82, and an OK button 83.

The display screen Q1 also shows, on its right half, a screen segment similar to the screen segment on the left half. Specifically, the display screen Q1 shows, on its right half, an alphabet display region 81a, an image display region 84a, an email address display region 82a, and an OK button 83a.

Two users each enter an email address for the user's portable terminal 3 at the same time on the screen illustrated in (b) of FIG. 7 (step S4). An individual user may enter a plurality of email addresses. The photograph sticker creating apparatus 4 may, in the case where it is arranged to set a limit to an email address entry period, be arranged to allow a user to enter a plurality of email addresses within the time limit.

The information entered as described above is received by the input section 54. When a user pressing the OK button 83 confirms the information entered, the input section 54 outputs the selected image and the entered email address to the communication section 57 together with a sticker ID (content identification information) for uniquely identifying the photograph image (step S5). The communication section 57 then transmits, to the management server 2, the email address, the photograph image, and the sticker ID in association with one another.

A photograph image selected and email address entered on the right half of the display screens Q and Q1 illustrated in FIG. 7 and those on the left half may be associated with respective sticker IDs different from each other.

Specifically, the present embodiment may be arranged such that a photograph image selected on the left half of the screen and an email address entered on the left half of the screen are associated with a sticker ID, while a photograph image selected on the right half of the screen and an email address entered on the right half of the screen are associated with another sticker ID. In other words, the photograph sticker creating apparatus 4 may create a plurality of sticker IDs for one or more photograph images created in a single play. In this case, a sticker ID serves as information identifying one or more photograph images that a user has selected from among one or more photograph images created in a single play.

The management server 2 may manage, in association with one another, a plurality of sticker IDs created by the photograph sticker creating apparatus 4 in a single play.

Further, photograph images identified by each of a plurality of sticker IDs created in a single play may all be identical to or different from one another, or some of such photograph images may be identical to one another.

The email address, the photograph image, and the sticker ID transmitted by the photograph sticker creating apparatus 4 are received by the communication section 21 of the management server 2 (step S11: receiving step). The communication section 21 outputs the information received to the receiving section 221, which in turn outputs the photograph image received to the temporary image saving performing section 222. The temporary image saving performing section 222 determines whether it has received any email address associated with the photograph image (step S12). In the case where the temporary image saving performing section 222 has determined that it has received an email address associated with the photograph image received (YES in step S12), the temporary image saving performing section 222 (i) stores, in the temporary saving section 241, the email address, the photograph image, and the sticker ID in association with one another, and also (ii) outputs, to the email creating section 225, the email address and the sticker ID both associated with the photograph image stored (step S13: temporary image saving performing step). In the case where the temporary image saving performing section 222 has determined that it has received no email address associated with the photograph image received (NO in step S12), the management server 2 ends the email transmission process.

The email creating section 225 creates an email addressed to the email address received. Specifically, the email creating section 225 outputs the email address and sticker ID received to the display page creating section 228, and instructs the display page creating section 228 to create a web page on which the user can obtain or save the photograph image identified by the sticker ID. The display page creating section 228, in response, (i) creates such a web page for saving a photograph image, and (ii) outputs, to the email creating section 225, a URL of the web page for saving a photograph image (or a display image having a hyperlink with that web page).

The email creating section 225 creates an email that is addressed to the email address and that includes the URL outputted from the display page creating section 228, and outputs the email created to the transmitting section 226. The transmitting section 226 in turn causes the communication section 21 to transmit the email to the email address (step S14).

The management server 2 performs an expiration alert process for a photograph image stored in the temporary saving section 241 (step S15). The description below deals with this expiration alert process with reference to FIG. 8.

First, the remaining save period determining section 224a determines whether the photograph image stored in the temporary saving section 241 has a remaining save period shorter than a predetermined period (step S151: remaining save period determining step). This determination is performed through a method detailed above, so the method is not described here. In the case where the remaining save period determining section 224a has determined that the photograph image has a remaining save period shorter than the predetermined period (YES in step S151), the remaining save period determining section 224a outputs, to the save state determining section 224c, the sticker ID associated with the photograph image.

The save state determining section 224c, upon receipt of the sticker ID, determines whether the user corresponding to the email address associated with the sticker ID has already saved, in a user dedicated storage area, the photograph image with which the sticker ID is associated (step S152: save state determining step). This determination is performed through a method detailed above, so the method is not described here. In the case where the save state determining section 224c has determined that the photograph image has not yet been saved in a user dedicated storage area (NO in step S152), the save state determining section 224c obtains, from the temporary saving section 241, the email address associated with the sticker ID, and outputs the email address to the member status determining section 224d.

In the case where (i) the remaining save period determining section 224a has determined that the photograph image has a remaining save period not shorter than the predetermined period (NO in step S151) or (ii) the save state determining section 224c has determined that the photograph image has already been saved in a user dedicated storage area (YES in step S152), the management server 2 ends the expiration alert process.

The description below deals with a member status-specific notification email transmission process with reference to FIG. 9 (step S153: transmitting step).

The member status determining section 224d, upon receipt of the email address, refers to member status information in the member status information storing section 243 to determine whether the user corresponding to the email address received is a member (step S31). In the case where the member status determining section 224d has determined that the user is a member (YES in step S31), the member status determining section 224d further determines whether the user is a paid member (step S32). In the case where the member status determining section 224d has determined that the user is a paid member (YES in step S32), the member status determining section 224d outputs, to the email creating section 225, the email address corresponding to the user and the member status information of the user's (that is, information indicating that the user is a paid member). In the case where the member status information includes a plurality of email addresses corresponding to the paid member, the member status determining section 224d may output, for example, an email address other than the email address associated with the sticker ID to the email creating section 225. The email creating section 225 refers to email information in the email information storing section 244 to create an email, customized to a paid member, for notification that the photograph image has not yet been saved in a user dedicated storage area. The email creating section 225 outputs the email created to the transmitting section 226. The transmitting section 226 in turn causes the communication section 21 to transmit the email to the email address corresponding to the user (that is, the email address received from the member status determining section 224d) (step S33).

In the case where the member status determining section 224d has determined that (i) the user corresponding to the email address received is not a member (NO in step S31) or (ii) the user corresponding to the email address received is not a paid member (NO in step S32), the member status determining section 224d outputs, to the email creating section 225, the email address corresponding to the user and the member status information of the user's (that is, information indicating that the user is a non-member or free member). The email creating section 225 refers to email information in the email information storing section 244 to create an email, customized to the member status, for notification that the photograph image has not yet been saved in a user dedicated storage area. The email creating section 225 outputs the email created to the transmitting section 226. The transmitting section 226 in turn causes the communication section 21 to transmit the email to the email address corresponding to the user (step S34 or S35).

The communication section 63 of the portable terminal 3 receives the email (step S21).

The communication section 63 outputs the email received to the display section 62, which in turn displays the email. The user checks the email displayed by the display section 62 and if the user wants to save the photograph image in a user dedicated storage area, selects the URL (or the hyperlinked display image) included in the email (step S22). The input section 60 responds to the user's selection by outputting, to the communication section 63, information indicating that the URL has been selected (URL selection information). The communication section 63 in turn transmits the URL selection information to the management server 2.

The URL selection information is received by the communication section 21 of the management server 2. The communication section 21 outputs the URL selection information received to the receiving section 221. The receiving section 221 then outputs the URL selection information via the user instruction executing section 227 to the display page creating section 228. The display page creating section 228 in response creates, for example, a web page for saving an image and outputs the web page created to the transmitting section 226. The transmitting section 226 in turn causes the communication section 21 to transmit the web page to the portable terminal 3.

The communication section 63 of the portable terminal 3 receives the web page and outputs the web page received to the display section 62, which in turn displays the web page received (step S23). This ends the email transmission process.

In summary, the management server 2 includes (i) a receiving section 221 (receiving means) for receiving a photograph image (content) and an email address entered at a photograph sticker creating apparatus 4 (content providing apparatus) for providing a photograph image (content) and associated with the photograph image, (ii) a temporary image saving performing section 222 (temporary saving performing means) for temporarily saving the photograph image and the email address in association with each other in a temporary saving section 241, (iii) a remaining save period determining section 224a (remaining save period determining means) for determining whether the photograph image in the temporary saving section 241 has a remaining save period shorter than a predetermined period extending from (a) the time point at which the temporary saving of the photograph image ends to (b) a predetermined time point set to come before the time point at which the temporary saving ends, (iv) a save state determining section 224c (save state determining means) for determining whether the photograph image has already been saved in a user dedicated storage area, and (v) a transmitting section 226 (transmitting means) for, in the case where (a) the remaining save period determining section 224a has determined that the remaining save period of the photograph image is shorter than the predetermined period and (b) the save state determining section 224c has determined that the photograph image has not yet been saved in the user dedicated storage area, transmitting to the email address an email for notification of the save state of the photograph image.

The above arrangement allows an email for notification of the save state of a photograph image to be transmitted to an email address, associated with a photograph image not yet saved in a user dedicated storage area, before the time point at which the temporary saving of the photograph image ends. The above arrangement thus allows the user to learn that the photograph image not yet saved in a user dedicated storage area has only a short period before the time limit for the temporary saving. The above arrangement can, as the result, prevent the user from forgetting to save, in a user dedicated storage area, content that has not yet been saved in such a dedicated storage area.

Further, the management server 2 may be arranged such that in the case where (i) the remaining save period determining section 224a has determined that the remaining save period of the photograph image is shorter than the predetermined period and (ii) the save state determining section 224c has determined that the photograph image has already been saved in the user dedicated storage area, the transmitting section 226 does not transmit an email for notification of the save state of the photograph image to the email address.

With the above arrangement, even if a photograph image non-temporarily saved by a portable terminal 3 has only a short period before the time limit for the temporary saving, the management server 2 does not transmit a notification email to that portable terminal 3 in the case where it has instructed the management server 2 to save the content in a user dedicated storage area. The above arrangement can, as the result, prevent a user, who has already saved the content in a user dedicated storage area and who does not need the notification email, from feeling bothered by receiving the unnecessary notification email.

The management server 2 may further include a user instruction executing section 227 (user instruction executing means) for, in accordance with an instruction from an external device (that is, a portable terminal 3 or another terminal [for example, a PC] of the user), saving, in the user dedicated storage area, the photograph image temporarily saved in the temporary saving section 241.

With the above arrangement, the management server 2 can accept, from an external device, an instruction to save a photograph image in a user dedicated storage area and save the photograph image in a user dedicated storage area.

The description below deals with images displayed on the portable terminal 3 of a user (as a non-member, a free member, or a paid member) when the portable terminal 3 has received the above notification email.

The email transmission system 1 includes the management server 2, the photograph sticker creating apparatus 4, and the portable terminal 3.

With the above arrangement, in the case where (i) an email address has been entered at the photograph sticker creating apparatus 4 in association with a photograph image, (ii) the photograph image has already been saved temporarily in the management server 2, and (iii) the photograph image has only a short period before the time limit for the temporary saving, the management server 2 can notify the portable terminal 3, which corresponds to the email address associated with the photograph image, of the save state of the photograph image.

The email transmission system 1 is further arranged such that (i) the photograph sticker creating apparatus 4 is a photograph sticker creating apparatus for photographing an object to create a photograph sticker and that (ii) the photograph image is an image of a photograph of the object.

With the above arrangement, the photograph sticker creating apparatus 4 provides a photograph image for the user. The above arrangement can thus prevent the user, during a process of saving the photograph image, from forgetting to non-temporarily save a photograph image.

(Images Displayed on Portable Terminal 3 of User as Non-Member)

FIG. 10 shows diagrams illustrating transition of images displayed on a portable terminal 3 of a user as a non-member.

(a) of FIG. 10 illustrates a display image P1 of an email for notification that a photograph image created by the non-member user has not yet been saved in a user dedicated storage area.

The display image P1 shows a time limit (temporary saving time limit) within which the user can view a photograph image that is saved temporarily in the temporary saving section 241.

The above arrangement can prevent a user from forgetting to non-temporarily save a photograph image.

The display image P1 includes (i) a hyperlinked display region 90 showing the text “this page”, (ii) a hyperlinked display region 91 showing the text “Get photo images”, and (iii) a hyperlinked display region 92 showing the text “See photo images”.

The user selecting the hyperlinked display region 91 or the hyperlinked display region 92 on the display image P1 causes the image displayed on the portable terminal 3 to transition to a display image P2 of a landing page illustrated in (b) of FIG. 10 (that is, a web page as the hyperlink destination).

(b) of FIG. 10 illustrates a display image P2 of a web page as the destination of the hyperlink of the display region 91 or 92 shown in (a) of FIG. 10.

The display image P2 includes (i) a thumbnail 93 of the photograph image not yet saved non-temporarily, (ii) a hyperlinked display region 94 showing the text “Register as paid member to save all photo images”, and (iii) a hyperlinked display region 95 showing the text “Register as free member to get photo image”.

The present embodiment may be arranged such that the photograph image indicated by the thumbnail 93 and not yet saved non-temporarily cannot be saved on the web page of the display image P2 but can be saved on a web page dedicated to the registered members.

The present embodiment may also be arranged such that the user selecting the display region 94 or the display region 95 causes the image displayed by the display section 62 of the portable terminal 3 to transition to an image of a web page for a user to register as a member.

The display image P2 also includes a hyperlinked display region 96 showing the text “Log in to save photo image”. The present embodiment may be arranged such that the user selecting the hyperlinked display region 96 causes the image displayed by the display section 62 of the portable terminal 3 to transition to an image of a web page for a member to log in.

The user selecting, on the display image P1, the hyperlinked display region 90 showing the text “this page” causes the image displayed on the portable terminal 3 to transition to a display image P3 illustrated in (c) of FIG. 10 of a web page for the user to stop the delivery of notification emails.

The above arrangement allows the management server 2 to (i) transmit, to a non-member user, a notification email for a non-member which email includes a display region having a hyperlink with a web page for a user to register as a member and thereby (ii) prompt such a non-member user to register as a member.

The present embodiment may be arranged such that the display image P1 shows information such as a URL of a location in the temporary saving section 241 in which location a photograph image is saved that has only a short period before the time limit for temporary saving. The user can, in this case, press an object showing the information to (i) directly access the location in which the photograph image is saved that has only a short period before the time limit for temporary saving, (ii) view the photograph image, and (iii) save the photograph image in a user dedicated storage area.

The display image P3 illustrated in (c) of FIG. 10, which is of a web page for a user to stop the delivery of notification emails, includes a display region 97 showing the text “Stop delivery”. The user selecting the display region 97 activates a mailer on the portable terminal 3. (d) of FIG. 10 illustrates a display image P4 displayed by the display section 62 of the portable terminal 3 in the case where a mailer on the portable terminal 3 has been activated. The present embodiment may be arranged such that a mailer on the portable terminal 3, when activated, automatically creates a new email with a predetermined email address already entered. The user can select a display region 98, included in the display image P4 and having the text “Send”, to send an email for stopping the delivery of notification emails.

(Images Displayed on Portable Terminal 3 of User as Free Member)

With reference to FIG. 11, the description below deals with transition of images displayed on a portable terminal 3 of a user as a free member.

(a) of FIG. 11 illustrates a display image P5 of an email for notification that a photograph image created by the user as a free member has not yet been saved in a user dedicated storage area.

The display image P5 shows a time limit (temporary saving time limit) within which the user can view a photograph image that is saved temporarily in the temporary saving section 241.

The above arrangement can prevent a user from forgetting to non-temporarily save a photograph image.

The display image P5 includes (i) a hyperlinked display region 90 showing the text “this page”, (ii) a hyperlinked display region 101 showing the text “Get photo images”, and (iii) a hyperlinked display region 102 showing the text “See photo images”. The hyperlinked display region 90 is described above with reference to FIG. 10, and is not described here.

The user selecting the hyperlinked display region 101 or the hyperlinked display region 102 on the display image P5 causes the image displayed on the portable terminal 3 to transition to a display image P6 of a landing page illustrated in (b) of FIG. 11 (that is, a web page as the hyperlink destination).

(b) of FIG. 11 illustrates a display image P6 of a web page as the destination of the hyperlink of the hyperlinked display region 101 or 102 shown in (a) of FIG. 11.

The present embodiment may be arranged such that in the case where, for instance, a single sticker ID is associated with a plurality of photograph images, a free member is allowed to non-temporarily save only one photograph image selected at the photograph sticker creating apparatus 4, whereas a paid member is allowed to non-temporarily save all photograph images created at the photograph sticker creating apparatus 4. Regardless of the member status of the user, the management server 2 saves, in the temporary saving section 241, all photograph images with which a sticker ID is associated. This means that while such photograph images with which a sticker ID is associated are saved in the temporary saving section 241, a free member (and a non-member) can become a paid member at any time to save all the photograph images non-temporarily.

The display image P6 includes (i) a thumbnail 93 of the photograph image not yet saved non-temporarily, (ii) a hyperlinked display region 104 showing the text “Register as paid member to save all photo images”, and (iii) a hyperlinked display region 105 showing the text “Save one image for free”.

The present embodiment may be arranged such that the user selecting the hyperlinked display region 104 showing the text “Register as paid member to save all photo images” causes the image displayed by the display section 62 of the portable terminal 3 to transition to an image of a web page for the user to register as a paid member.

The present embodiment may also be arranged such that the user selecting the hyperlinked display region 105 showing the text “Save one image for free” causes the image displayed by the display section 62 of the portable terminal 3 to transition to an image of a web page for the user to save an image non-temporarily.

(Images Displayed on Portable Terminal 3 of User as Paid Member)

With reference to FIG. 12, the description below deals with transition of images displayed on a portable terminal 3 of a user as a paid member.

(a) of FIG. 12 illustrates a display image P7 of an email for notification that a photograph image created by the user as a paid member has not yet been saved in a user dedicated storage area.

The display image P7 shows a time limit (temporary saving time limit) within which the user can view a photograph image that is saved temporarily in the temporary saving section 241.

The above arrangement can prevent a user from forgetting to non-temporarily save a photograph image.

The display image P7 includes (i) a hyperlinked display region 90 showing the text “this page” and (ii) a hyperlinked display region 111 showing the text “Get photo images”. The hyperlinked display region 90 is described above with reference to FIG. 10, and is not described here.

The user selecting the hyperlinked display region 111 on the display image P7 causes the image displayed on the portable terminal 3 to transition to a display image P8 of a landing page illustrated in (b) of FIG. 12 (that is, a web page as the hyperlink destination).

(b) of FIG. 12 illustrates a display image P8 of a web page as the destination of the hyperlink of the hyperlinked display region 111 shown in (a) of FIG. 12.

The present embodiment may be arranged such that in the case where, for instance, a single sticker ID is associated with a plurality of photograph images, a paid member is allowed to save all images created at the photograph sticker creating apparatus 4.

The display image P8 includes (i) a thumbnail 93 of the photograph image not yet saved non-temporarily and (ii) a hyperlinked display region 114 showing the text “Save all photo images”.

The present embodiment may be arranged such that the user selecting the hyperlinked display region 114 showing the text “Save all photo images” causes the image displayed by the display section 62 of the portable terminal 3 to transition to an image of a web page for the user to save images non-temporarily.

The description above deals with example images displayed on the portable terminal 3 in the case where the portable terminal 3 has received an email for notification that a photograph image has not yet been saved non-temporarily. In the case where, for instance, the user has accessed a web page for viewing a photograph image before an email is transmitted to the user for notification that a photograph image has not yet been saved non-temporarily, such a web page for viewing a photograph image may have display content that varies according to, for example, (i) the member status of the user accessing the web page, (ii) how the user has accessed the web page recently, and/or (iii) the history of the user's accessing the web page. The present embodiment may also be arranged, for instance, such that the web page for viewing a photograph image shows, when accessed by a user, an alert of the text “Your images will be deleted in N days” or the like.

The description below deals with a web page for viewing a photograph image which web page is displayed in the case where the photograph image has a remaining save period shorter than a predetermined period extending from (i) the time point at which temporary saving of the photograph image ends to (ii) the predetermined time point set to come before the time point at which the temporary saving ends and where the photograph image has not yet been saved in a user dedicated storage area.

The present embodiment may be arranged such that a web page for a non-member user to view a photograph image includes (i) a region to display the remaining save period of the photograph image and (ii) a hyperlinked display region (banner display) showing the text “Become a member”. In this case, the user selecting the hyperlinked display region may cause the image displayed on the portable terminal 3 to transition to an image of a web page for registering as a member.

The above arrangement provides a web page for a non-member to view a photograph image, the web page including a display region having a hyperlink with a web page for registering as a member, and can thereby prompt such a non-member user to register as a member.

The present embodiment may be arranged such that a web page for a member user to view a photograph image includes a region to display the remaining save period of the photograph image.

The above arrangement can prompt a user who has not yet non-temporarily saved a photograph image to save such a photograph image in a user dedicated storage area.

(Variation 1)

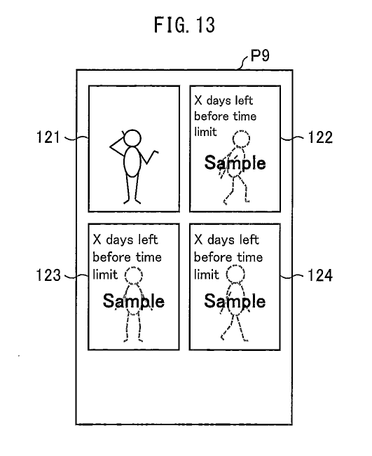

FIG. 13 illustrates a display image P9 according to Variation 1 of a web page for viewing photograph images which is displayed on a portable terminal 3 of a user as a free member. The present variation is arranged, for instance, such that in the case where a single sticker ID is associated with a plurality of photograph images, a free member is allowed to non-temporarily save only one photograph image, whereas a paid member is allowed to non-temporarily save all photograph images created.

The display image P9 shows a photograph image 121, which has already been saved non-temporarily, with the colors as indicated by the data on the photograph image 121.

The display image P9, on the other hand, shows photograph images 122, 123, and 124, none of which has already been saved non-temporarily, as grayed out. Further, the photograph images 122, 123, and 124 are each shown in a display region that also shows a time limit for temporary saving. The present variation may be arranged such that the user selecting any of the photograph images 122, 123, and 124 (none of which has already been saved non-temporarily) causes the image displayed by the display section 62 of the portable terminal 3 to transition to an image of a web page for the user to register as a paid member.

(Variation 2)

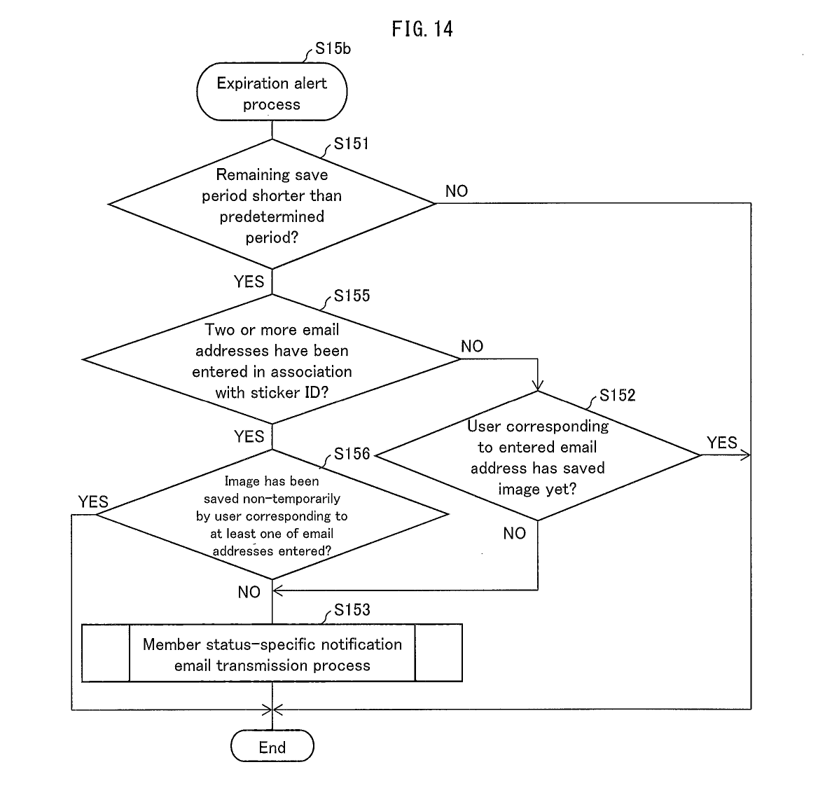

A variation of the present invention is described below with reference to FIG. 14. For convenience of explanation, any member of the present variation that is identical in function to a member described in the embodiment above is assigned a common reference numeral, and is not described here.

The present variation is a variation of the expiration alert process. The present variation is arranged as follows: In the case where (i) a plurality of different email addresses entered are associated with a photograph image and (ii) the photograph image has already been saved, by the user corresponding to at least one of the email addresses, in a user dedicated storage area, the management server 2 does not transmit, to the user(s) corresponding to the other email address(es) entered, an email for notification that the photograph image has not yet been saved non-temporarily. In other words, the management server 2, in the above case, does not transmit such a notification email to the portable terminal(s) 3 corresponding to the other email address(es) entered (that is, the portable terminal(s) 3 that receives emails which are addressed to the email address(es) entered).

FIG. 14 is a flowchart of an expiration alert process S15b of the present variation.

The description below deals with steps different from those of the expiration alert process S15 illustrated in FIG. 8. In the case where the remaining save period determining section 224a has determined that the photograph image has a remaining save period shorter than the predetermined period (YES in step S151), the remaining save period determining section 224a outputs, to the address number determining section 224b, the sticker ID associated with the photograph image. The address number determining section 224b then determines whether two or more email addresses are associated with the sticker ID received (step S155). In the case where the address number determining section 224b has determined that two or more email addresses are associated with the sticker ID received by the remaining save period determining section 224a (YES in step S155), the address number determining section 224b outputs, to the save state determining section 224c, the sticker ID and information indicating that two or more email addresses are associated with the sticker ID.

The save state determining section 224c, upon receipt of the sticker ID and the information indicating that two or more email addresses are associated with the sticker ID, determines whether the photograph image has already been saved, by the user corresponding to at least one of the plurality of email addresses, in a user dedicated storage area (step S156). This determination is detailed above, and is not described here. In the case where the save state determining section 224c has determined that the photograph image has already been saved, by the user corresponding to at least one of the plurality of email addresses, in a user dedicated storage area (YES in step S156), the expiration alert process S15 ends. In the case where the save state determining section 224c has determined that the photograph image has not yet been saved, by the user corresponding to at least one of the plurality of email addresses, in a user dedicated storage area (NO in step S156), the save state determining section 224c obtains, from the temporary saving section 241, the email address(es) associated with the sticker ID, and outputs the email address(es) to the member status determining section 224d. The expiration alert process S15 then proceeds to the member status-specific notification email transmission process (step S153) described above.

In the case where the address number determining section 224b has determined that only one email address is associated with the sticker ID received by the remaining save period determining section 224a (NO in step S155), the expiration alert process S15 then proceeds to the step S152.

In summary, the management server 2 of the present variation may be arranged such that the email address received by the receiving section 221 includes a plurality of different email addresses associated with the content, that the save state determining section 224c determines whether the photograph image has already been saved, in accordance with an instruction from a portable terminal 3 of at least one of users corresponding to the different email addresses, in the user dedicated storage area, and that in the case where the save state determining section 224c has determined that the photograph image has already been saved, in accordance with the instruction, in the storage area dedicated to the at least one user, the transmitting section 226 does not transmit an email for notification of the save state of the content to any of the email addresses.

With the above arrangement, in the case where any one of the portable terminals 3 corresponding to the email addresses associated with a photograph image has instructed the management server 2 to save the photograph image in a user dedicated storage area, the management server 2 may not transmit an email for notification of the save state of the photograph image to any of the email addresses. The management server 2 may, in other words, not transmit an email for notification of the save state of a photograph image that has been already saved by any user in a storage area dedicated to that user. The above arrangement can, as the result, prevent a user, who does not need the notification email, from feeling bothered by receiving the unnecessary notification email.

(Variation 3)

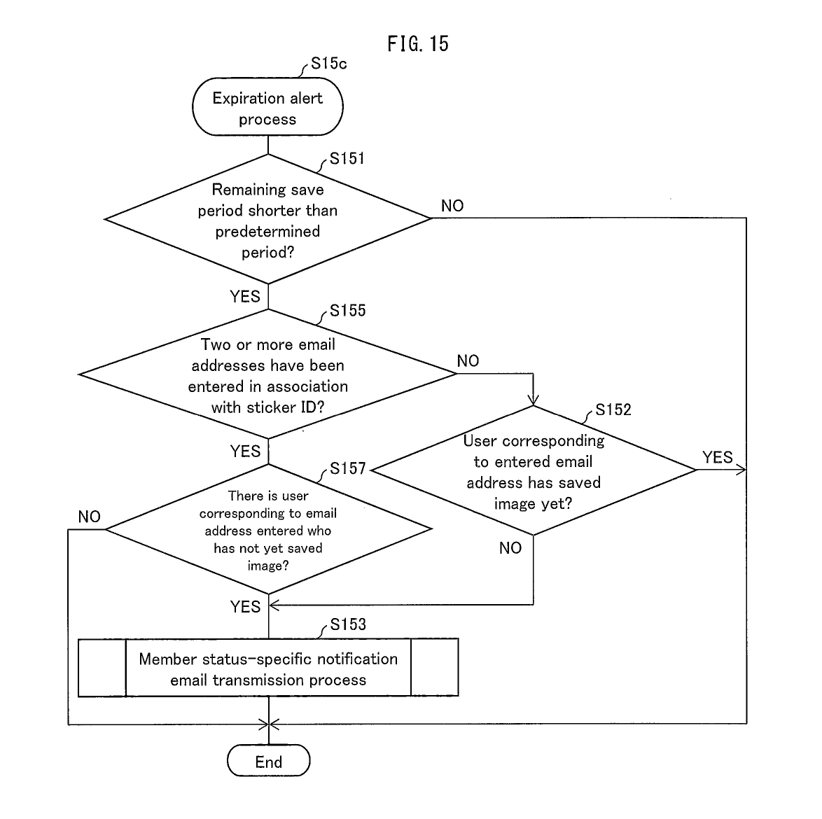

A variation of the present invention is described below with reference to FIG. 15. For convenience of explanation, any member of the present variation that is identical in function to a member described in the embodiment or any variation above is assigned a common reference numeral, and is not described here.

The present variation is another variation of the expiration alert process.

The present variation is a variation of the expiration alert process, and is arranged as follows: A plurality of different email addresses entered are associated with a photograph image, and the management server 2 transmits, to a user who has not yet saved the photograph image in a user dedicated storage area (that is, to an email address corresponding to that user's portable terminal 3), an email for notification that the photograph image has not yet been saved non-temporarily.

FIG. 15 is a flowchart of an expiration alert process S15c of the present variation.

The description below deals with those steps of the expiration alert process S15c of the present variation which are different from those of the expiration alert process S15b illustrated in FIG. 14.

In the case where the address number determining section 224b has determined that two or more email addresses are associated with the sticker ID received by the remaining save period determining section 224a (YES in step S155), the address number determining section 224b outputs, to the save state determining section 224c, the sticker ID and information indicating that two or more email addresses are associated with the sticker ID.

The save state determining section 224c, upon receipt of the sticker ID and the information indicating that two or more email addresses are associated with the sticker ID, determines whether any of the users corresponding to the plurality of email addresses has not yet saved a photograph image in a user dedicated storage area (step S157). This determination is detailed above, and is not described here. In the case where the save state determining section 224c has determined that at least one of the users corresponding to the plurality of email addresses has not yet saved a photograph image in a user dedicated storage area (YES in step S157), the save state determining section 224c (i) obtains, from the temporary saving section 241, the email address corresponding to the user who has not yet saved a photograph image in a user dedicated storage area and (ii) outputs the email address to the member status determining section 224d. The expiration alert process S15c then proceeds to the member status-specific notification email transmission process (step S153) described above.

In the case where the save state determining section 224c has determined that none of the users corresponding to the plurality of email addresses has not saved a photograph image in a user dedicated storage area (NO in step S157), the expiration alert process S15c ends.

In summary, the management server 2 of the present variation may be arranged such that the email address received by the receiving section 221 includes a plurality of different email addresses associated with the photograph image, that the save state determining section 224c determines, for each of portable terminals 3 of users corresponding to the email addresses, whether the photograph image has already been saved, in accordance with respective instructions from the portable terminals 3, in the user dedicated storage area, and that the transmitting section 226 transmits an email for notification of the save state of the photograph image to an email address corresponding to a portable terminal 3 that has not yet instructed the management apparatus to save the photograph image in the user dedicated storage area.

The above arrangement allows an email for notification of the save state of a photograph image to be transmitted to an email address corresponding to a portable terminal 3 that has not yet instructed the management server 2 to save the content in a dedicated storage area. The above arrangement, in other words, allows an email for notification of the save state of a photograph image to be transmitted to an email address corresponding to a portable terminal 3 that has not yet instructed the management server 2 to save the photograph image (that is, a user who needs to receive an email for notification of the save state of the content). The above arrangement, as the result, allows a notification email to be transmitted to only a portable terminal 3 of a user who may have forgotten to non-temporarily save content.

The management server 2 of the present variation may also be arranged such that the email address received by the receiving section 221 includes a plurality of different email addresses associated with the photograph image, that the save state determining section 224c determines, for each of users corresponding to the email addresses associated with the photograph image, whether the photograph image has already been saved by the users in storage areas dedicated to the users, and that the transmitting section 226 transmits an email for notification of the save state of the photograph image to an email address corresponding to a user who has not yet saved the photograph image in a user dedicated storage area.

(Variation 4)

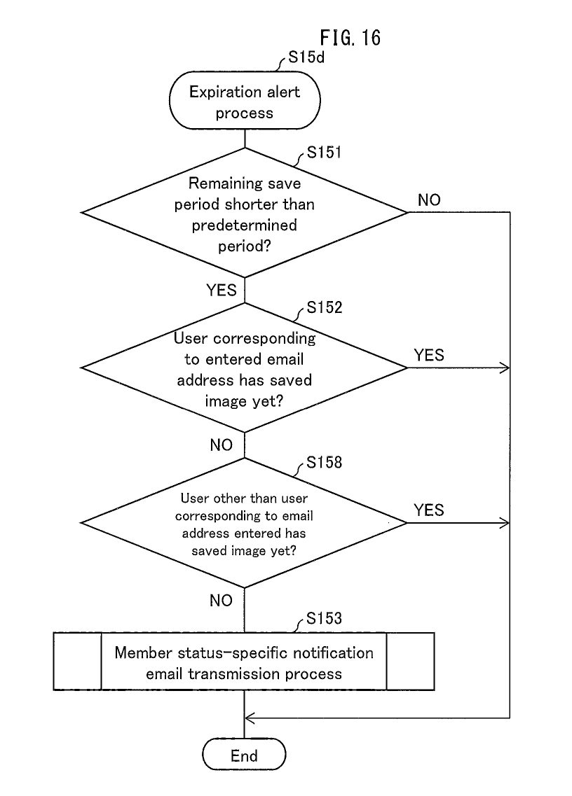

A variation of the present invention is described below with reference to FIG. 16. For convenience of explanation, any member of the present variation that is identical in function to a member described in the embodiment above is assigned a common reference numeral, and is not described here.

The present variation is a variation of the expiration alert process, and is arranged as follows: In the case where a user other than the user(s) corresponding to the email address(es) entered (that is, the portable terminal(s) 3 corresponding to the email address(es) entered) has already saved a photograph image in a storage area dedicated to the other user, the management server 2 does not transmit, to the user corresponding to the email address entered, an email for notification that the photograph image has not yet been saved non-temporarily.

FIG. 16 is a flowchart of an expiration alert process S15d.

The description below deals with those steps of the expiration alert process S15d which are different from those of the expiration alert process S15 illustrated in FIG. 8.

In the case where the save state determining section 224c has determined that the photograph image has not yet been saved in a user dedicated storage area (NO in step S152), the save state determining section 224c further determines whether a user other than the user(s) corresponding to the email address(es) entered has already saved the photograph image in a storage area dedicated to the other user (step S158).

In the case where the save state determining section 224c has determined that a user other than the user(s) corresponding to the email address(es) entered has already saved the photograph image in a storage area dedicated to the other user (YES in step S158), the expiration alert process S15d ends. In the case where the save state determining section 224c has determined that no user other than the user(s) corresponding to the email address(es) entered has already saved the photograph image in a storage area dedicated to the other user (NO in step S158), the save state determining section 224c obtains, from the temporary saving section 241, the email address(es) associated with the sticker ID, and outputs the email address(es) to the member status determining section 224d. The expiration alert process S15d then proceeds to the member status-specific notification email transmission process (step S153) described above.

In summary, the management server 2 of the present invention may be arranged such that the save state determining section 224c further determines whether the photograph image has already been saved, in accordance with an instruction from a portable terminal 3 other than the portable terminal 3 corresponding to the email address associated with the photograph image (that is, the portable terminal 3 that receives an email addressed to the email address), in the user dedicated storage area and that in the case where the save state determining section 224c has determined that the photograph image has already been saved in the user dedicated storage area in accordance with the instruction, the transmitting section 226 does not transmit an email for notification of the save state of the photograph image to any email address.

With the above arrangement, an email for notification of the save state of a photograph image may not be transmitted to any user in the case where a user other than the user corresponding to the email address associated with the photograph image has already saved the photograph image in a storage area dedicated to the other user. In other words, in the case where any user has already saved a photograph image in a user dedicated storage area, the management server 2 does not transmit an email for notification of the save state of that photograph image to any user. The above arrangement can, as the result, prevent a user, who does not need the notification email, from feeling bothered by receiving the unnecessary notification email.

The management server 2 of the present invention may also be arranged such that the save state determining section 224c further determines whether the photograph image has already been saved, by a user other than the user corresponding to the email address associated with the photograph image, in a storage area dedicated to the other user, and that in the case where the save state determining section 224c has determined that the photograph image has already been saved, by a user other than the user corresponding to the email address associated with the photograph image, in a storage area dedicated to the other user, the transmitting section 226 does not transmit an email for notification of the save state of the photograph image to any email address associated with the photograph image.

(Variation 5)

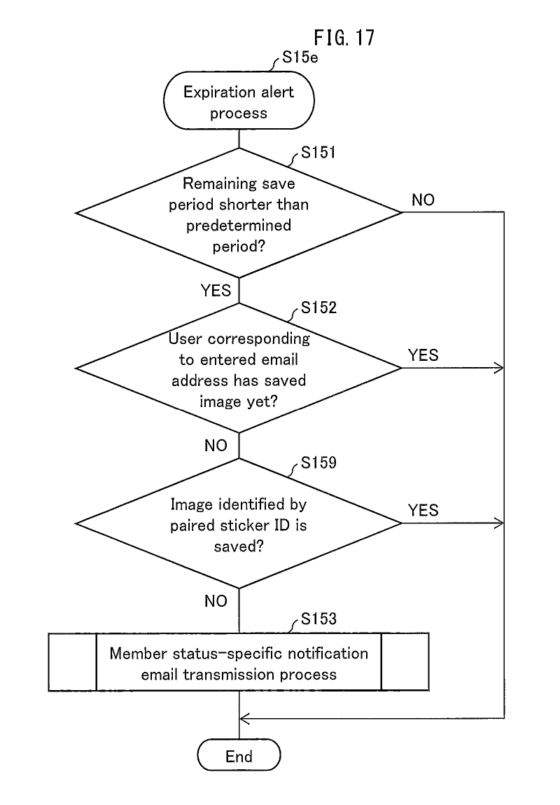

A variation of the present invention is described below with reference to FIG. 17.

For convenience of explanation, any member of the present variation that is identical in function to a member described in the embodiment above is assigned a common reference numeral, and is not described here.

The present variation is a variation of the expiration alert process, and is arranged as follows: In the case where a first user and a second user have played a game together and the second user has already saved a photograph image created in the play, the management server 2 does not transmit, to the first user, an email for notification that the photograph image created in the play has not yet been saved non-temporarily.

The description above deals with paired sticker IDs, and such paired sticker IDs are not described here.

FIG. 17 is a flowchart of an expiration alert process S15e.

The description below deals with those steps of the expiration alert process S15e which are different from those of the expiration alert process S15 illustrated in FIG. 8.

In the case where the save state determining section 224c has determined that the photograph image has not yet been saved in a user dedicated storage area (NO in step S152), the save state determining section 224c further determines whether a photograph image (second photograph image; second content) identified by a sticker ID (second sticker ID) that is other than the sticker ID (first sticker ID) identifying the above photograph image (first photograph image; first content) and that belongs to the same play as the first sticker ID has already been saved in a user dedicated storage area (step S159). Sticker IDs created in a single play share the same information for identifying the play but differ from each other in the other information. Such sticker IDs can thus be referred to as paired sticker IDs.

In the case where the save state determining section 224c has determined that a second photograph image identified by the second sticker ID has already been saved in a user dedicated storage area (YES in step S159), the expiration alert process S15e ends. In the case where the save state determining section 224c has determined that a second photograph image identified by the second sticker ID has not yet been saved in a user dedicated storage area (NO in step S159), the save state determining section 224c obtains, from the temporary saving section 241, the email address(es) associated with the first sticker ID and outputs the email address(es) to the member status determining section 224d. The expiration alert process S15e then proceeds to the member status-specific notification email transmission process (step S153) described above.

In summary, the management server 2 of the present variation may be arranged such that the photograph image is a first photograph image, that the receiving section 221 receives, in addition to the first photograph image, a second photograph image created in the same play as the first photograph image, that the temporary image saving performing section 222 temporarily saves the first photograph image and the second photograph image in the temporary saving section 241, and that in the case where the save state determining section 224c has determined that the second photograph image has already been saved in the user dedicated storage area, the transmitting section 226 does not transmit an email for notification of the save state of the first photograph image to the email address associated with the photograph image.

With the above arrangement, the transmitting section 226 does not transmit a notification email to the email address, associated with a photograph image, in the case where another photograph image created in the same play has already been saved.

Photograph images identified by each of a plurality of sticker IDs created in a single play may all be identical to or different from one another, or some of such photograph images may be identical to one another.

In the case where another photograph image created in the same play has already been saved, it means that another user in that play has already saved, in a user dedicated storage area, part or all of the photograph images created in the play.

The management server 2, as the result, may not transmit a notification email to a user who, since another user in the same play has already saved a photograph image created in the play, does not need to be notified that a photograph image created in the play has not yet been saved in a user dedicated storage area.

(Variation 6)

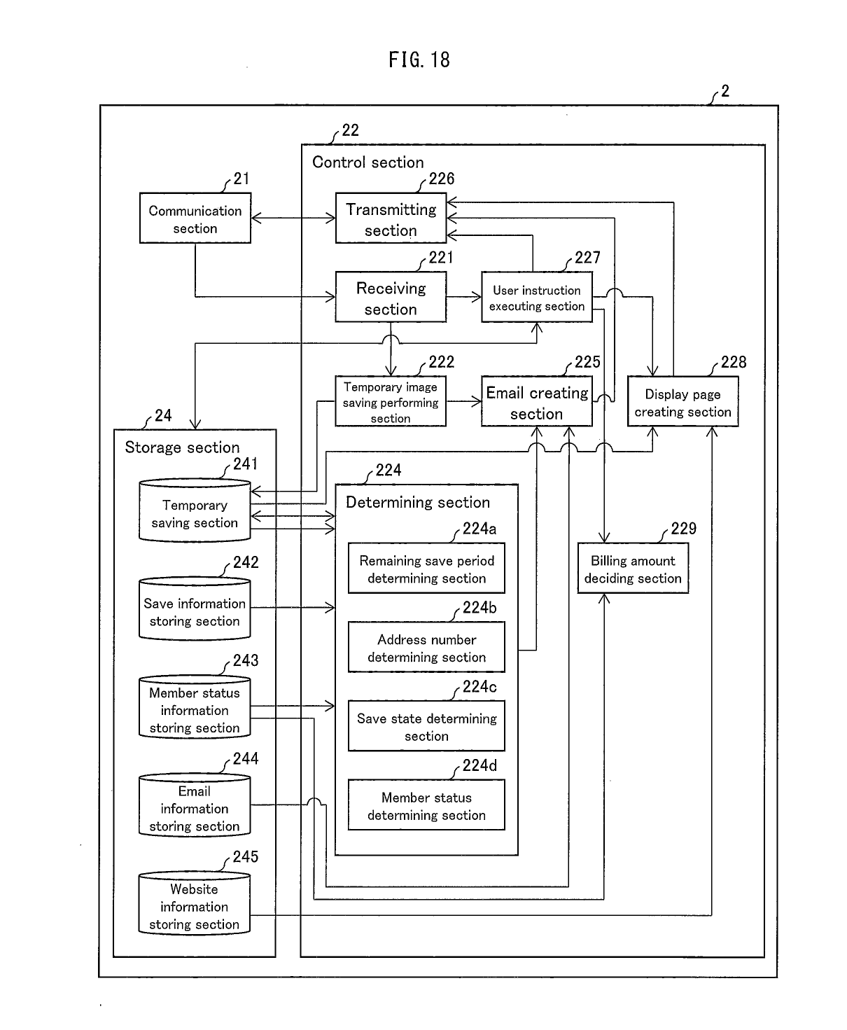

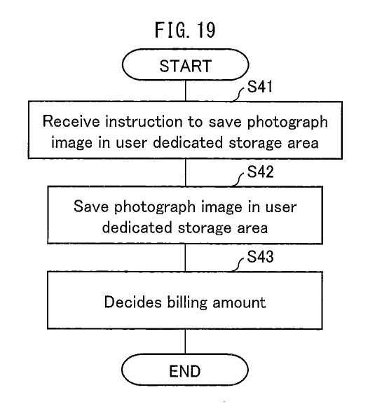

A variation of the present invention is described below with reference to FIGS. 18 and 19. For convenience of explanation, any member of the present variation that is identical in function to a member described in the embodiment above is assigned a common reference numeral, and is not described here.

The present variation is arranged such that the management server 2 further includes a billing amount deciding section 229 as illustrated in FIG. 18. The billing amount deciding section 229 decides a billing amount for the user.

Specifically, the present variation may be arranged such that the billing amount deciding section 229 receives, from the user instruction executing section 227, a notification indicative of (i) the user who has already saved one or more photograph images in a user dedicated storage area and (ii) the number of the photograph images that the user has already saved in the dedicated storage area and that the billing amount deciding section 229 decides a billing amount for the user in accordance with the number of the photograph images that the user has already saved in the user dedicated storage area. The billing amount deciding section 229 may, for instance, set a per-piece price on a photograph image already saved in the dedicated storage area and thus calculate a billing amount for the user. The billing amount deciding section 229 may alternatively refer to save information in the save information storing section 242 to decide a billing amount for the user.

Further, the billing amount deciding section 229 may refer to member status information in the member status information storing section 243 to decide a billing amount for the user in accordance with the member status of the user. The billing amount deciding section 229 may, for example, decide that a monthly billing amount for a user as a paid member is a predetermined amount of money.

With reference to FIG. 19, the description below deals with a billing amount deciding process performed by the management server 2. FIG. 19 is a flowchart illustrating an example of the billing amount deciding process performed by the management server 2.

First, as illustrated in FIG. 19, the receiving section 221 receives, from the portable terminal 3, an instruction to save one or more photograph images in a user dedicated storage area (S41). Then, the user instruction executing section 227, in accordance with the instruction received by the receiving section 221, saves the photograph images in a user dedicated storage area (S42). The user instruction executing section 227, after saving the photograph images in the user dedicated storage area, notifies the billing amount deciding section 229 of (i) the user who has already saved the photograph images in the dedicated storage area and (ii) the number of the photograph images saved in the dedicated storage area. The billing amount deciding section 229 in turn decides a billing amount for the user on the basis of the notification from the user instruction executing section 227 (S43).

The user instruction executing section 227 may, after saving the photograph images in the user dedicated storage area in S42, update save information in the save information storing section 242 and notify the billing amount deciding section 229 that the user instruction executing section 227 has updated the save information. In this case, the billing amount deciding section 229 may, upon receipt of the notification from the user instruction executing section 227, refer to the save information in the save information storing section 242 to decide a billing amount for the user in S43.

[Recap]

In order to solve the above problem, a management apparatus of the present invention is a management apparatus including: a receiving section for receiving (i) content, which is a photograph image, created by a content providing apparatus and (ii) an email address entered at the content providing apparatus and associated with the content; a performing section for temporarily saving the content and the email address in association with each other in a temporary saving section; a remaining save period determining section for determining whether the content in the temporary saving section has a remaining save period shorter than a predetermined period; a save state determining section for determining whether the content has already been saved in a user dedicated storage area; and a transmitting section for, in a case where (i) the remaining save period determining section has determined that the remaining save period of the content is shorter than the predetermined period and (ii) the save state determining section has determined that the content has not yet been saved in the user dedicated storage area, transmitting to the email address an email for notification of a save state of the content.

In order to solve the above problem, a method of the present invention for controlling a management apparatus is a method for controlling a management apparatus, the method including: a receiving step for receiving (i) content, which is a photograph image, created by a content providing apparatus and (ii) an email address entered at the content providing apparatus and associated with the content; a performing step for temporarily saving the content and the email address in association with each other in a temporary saving section; a remaining save period determining step for determining whether the content in the temporary saving section has a remaining save period shorter than a predetermined period; a save state determining step for determining whether the content has already been saved in a user dedicated storage area; and a transmitting step for, in a case where (i) the remaining save period determining step has determined that the remaining save period of the content is shorter than the predetermined period and (ii) the save state determining step has determined that the content has not yet been saved in the user dedicated storage area, transmitting to the email address an email for notification of a save state of the content.

The above arrangement allows an email for notification of the save state of content to be transmitted to an email address, associated with content not yet saved in a user dedicated storage area, before the time point at which the temporary saving of the content ends. The above arrangement thus allows the user to learn that the content not yet saved in a user dedicated storage area has only a short period before the time limit for the temporary saving in the temporary saving section. The above arrangement can, as the result, prevent the user from forgetting to save, in a user dedicated storage area, content that has not yet been saved in such a dedicated storage area.

The management apparatus of the present invention may be arranged such that in a case where (i) the remaining save period determining section has determined that the remaining save period of the content is shorter than the predetermined period and (ii) the save state determining section has determined that the content has already been saved in the user dedicated storage area, the transmitting section does not transmit the email to the email address.

With the above arrangement, even if content temporarily saved by a communication terminal has only a short period before the time limit for the temporary saving, the management apparatus does not transmit a notification email to that communication terminal in the case where it has instructed the management apparatus to save the content in a user dedicated storage area. The above arrangement can, as the result, prevent a user, who has already saved the content in a user dedicated storage area and who does not need the notification email, from feeling bothered by receiving the unnecessary notification email.

The management apparatus of the present invention may be arranged such that the email address received by the receiving section includes a plurality of email addresses associated with the content; the save state determining section determines whether the content has already been saved, in accordance with an instruction from a communication terminal of at least one of users corresponding to the email addresses, in the user dedicated storage area; and in a case where the save state determining section has determined that the content has already been saved, in accordance with the instruction, in the storage area dedicated to the at least one user, the transmitting section does not transmit the email to any of the email addresses.

With the above arrangement, in the case where a communication terminal of a user corresponding to any one of the email addresses associated with the content has instructed the management apparatus to save the content in a user dedicated storage area, the management apparatus may not transmit an email for notification of the save state of the content to any of the email addresses. The management apparatus may, in other words, not transmit an email for notification of the save state of content that has been already saved by any user in a storage area dedicated to that user. The above arrangement can, as the result, prevent a user, who does not need the notification email, from feeling bothered by receiving the unnecessary notification email.

The management apparatus of the present invention may be arranged such that the email address received by the receiving section includes a plurality of email addresses associated with the content; the save state determining section determines, for each of communication terminals of users corresponding to the email addresses, whether the content has already been saved, in accordance with respective instructions from the communication terminals, in the user dedicated storage area; and the transmitting section transmits the email to an email address corresponding to a communication terminal that has not yet instructed the management apparatus to save the content in the user dedicated storage area.

The above arrangement allows an email for notification of the save state of content to be transmitted to an email address corresponding to a communication terminal that has not yet instructed the management apparatus to save the content in a dedicated storage area. The above arrangement, in other words, allows an email for notification of the save state of content to be transmitted to an email address corresponding to a communication terminal that has not yet instructed the management apparatus to save the content (that is, a user who needs to receive an email for notification of the save state of the content). The above arrangement, as the result, allows a notification email to be transmitted to only a communication terminal of a user who may have forgotten to non-temporarily save content.

The management apparatus of the present invention may be arranged such that the save state determining section further determines whether the content has already been saved in the user dedicated storage area in accordance with an instruction from a communication terminal other than a communication terminal corresponding to the email address; and in a case where the save state determining section has determined that the content has already been saved in the user dedicated storage area in accordance with the instruction, the transmitting section does not transmit the email to the email address.

With the above arrangement, an email for notification of the save state of content may not be transmitted to any user in the case where a user other than the user corresponding to the email address associated with the content has already saved the content in a storage area dedicated to the other user. In other words, in the case where any user has already saved content in a user dedicated storage area, the management apparatus does not transmit an email for notification of the save state of that content to any user. The above arrangement can, as the result, prevent a user, who does not need the notification email, from feeling bothered by receiving the unnecessary notification email.

The management apparatus of the present invention may be arranged such that the content is first content; the receiving section receives, in addition to the first content, second content created in a same play as the first content; the performing section temporarily saves the first content and the second content in the temporary saving section; and in a case where the save state determining section has determined that the second content has already been saved in the user dedicated storage area, the transmitting section does not transmit the email to the email address.

With the above arrangement, the transmitting section does not transmit a notification email to the email address, associated with content, in the case where other content created in the same play as the above content has already been saved.

In the case where other content created in the same play has already been saved, it means that another user in that play has already saved, in a user dedicated storage area, part or all of the content created in the play.

The management apparatus, as the result, may not transmit a notification email to a user who, since another user in the same play has already saved content created in the play, does not need to be notified that content created in the play has not yet been saved in a user dedicated storage area.

The management apparatus of the present invention may further include a user instruction executing section for, in accordance with an instruction from an external device, saving, in the user dedicated storage area, the content temporarily saved in the temporary saving section.

With the above arrangement, the management apparatus can accept, from an external device, an instruction to save content in a user dedicated storage area and save the content in a user dedicated storage area.

The management apparatus of the present invention may be arranged such that the email transmitted by the transmitting section varies according to a member status of a user corresponding to the email address.

With the above arrangement, the transmitting section transmits an email customized to each member status.

The management apparatus of the present invention may be arranged such that member statuses include a paid member, a free member, and a non-member.

With the above arrangement, the transmitting section transmits an email customized to each member status, namely a paid member, a free member, and a non-member.

The management apparatus of the present invention may be arranged such that the email transmitted by the transmitting section (i) in a case where the member status of the user is a non-member, prompts the user to become a member and (ii) in a case where the member status of the user is a free member, prompts the user to become a paid member.

With the above arrangement, the transmitting section transmits (i) to a user as a non-member, an email that prompts the user to become a member and (ii) to a user as a free member, an email that prompts the user to become a paid member. The management apparatus can, as the result, help increase the number of members (including paid members).

The management apparatus of the present invention may further include a billing amount deciding section for deciding a billing amount for a user in accordance with a number of the photograph image that the user saves in the user dedicated storage area.

With the above arrangement, the billing amount deciding section can decide a billing amount for a user in accordance with the number of photograph images that the user saves in a user dedicated storage area.

An email transmission system of the present invention includes the management apparatus, a content providing apparatus, and a communication terminal.

With the above arrangement, in the case where (i) an email address has been entered at the content providing apparatus in association with content, (ii) the content has already been saved temporarily in the management apparatus, and (iii) the content has only a short period before the time limit for the temporary saving, the management apparatus can notify the communication terminal, which corresponds to the email address associated with the content, of the save state of the content.

The email transmission system of the present invention is further arranged such that (i) the content providing apparatus is a photograph sticker creating apparatus for photographing an object to create a photograph sticker and that (ii) the content is an image of a photograph of the object.

With the above arrangement, the photograph sticker creating apparatus provides a photograph image for the user. The above arrangement can thus prevent the user, during a process of saving the photograph image, from forgetting to non-temporarily save a photograph image.

The management apparatus according to the foregoing embodiments of the present invention may be in the form of a computer. In this case, the present invention encompasses: a control program for the management apparatus which program causes a computer to operate as each of the above means of the management apparatus so that the management apparatus can be in the form of a computer; and a computer-readable recording medium computer-readable storage/recording medium storing the control program.

[Software Implementation Example]

Control blocks of the management server 2 (particularly, the determining section 224) may be realized by a logic circuit (hardware) provided in an integrated circuit (IC chip) or the like, or may be realized by software as executed by a central processing unit (CPU).

In the latter case, the management server 2 includes: a CPU that executes instructions of a program that is software realizing the foregoing functions; a read only memory (ROM) or storage device (each referred to as “storage medium”) storing the program and various kinds of data in such a form that they are readable by a computer (or a CPU); and a random access memory (RAM) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### INDUSTRIAL APPLICABILITY

The present invention is widely applicable to a management server for managing (i) an image that a photograph sticker creating apparatus has created by taking a photograph of a user, in association with (ii) an email address corresponding to the user.

### REFERENCE SIGNS LIST

1 email transmission system

2 management server (management apparatus)

3 portable terminal (communication terminal)

4 photograph sticker creating apparatus (content providing apparatus)

221 receiving section (receiving means)

222 temporary image saving performing section (performing section, performing means)

224a remaining save period determining section (remaining save period determining means)

224c save state determining section (save state determining means)

226 transmitting section (transmitting means)

227 user instruction executing section (user instruction executing means)

241 temporary saving section

S11 receiving step

S13 performing step

S151 remaining save period determining step

S152 save state determining step

S153 transmitting step

1. A management apparatus comprising:
a receiving section for receiving (i) content, which is a photograph image, created by a content providing apparatus and (ii) an email address entered at the content providing apparatus and associated with the content;
a performing section for temporarily saving the content and the email address in association with each other in a temporary saving section;
a remaining save period determining section for determining whether the content in the temporary saving section has a remaining save period shorter than a predetermined period;
a save state determining section for determining whether the content has already been saved in a user dedicated storage area; and
a transmitting section for, in a case where (i) the remaining save period determining section has determined that the remaining save period of the content is shorter than the predetermined period and (ii) the save state determining section has determined that the content has not yet been saved in the user dedicated storage area, transmitting to the email address an email for notification of a save state of the content.

2. The management apparatus according to claim 1,
wherein
in a case where (i) the remaining save period determining section has determined that the remaining save period of the content is shorter than the predetermined period and (ii) the save state determining section has determined that the content has already been saved in the user dedicated storage area, the transmitting section does not transmit the email to the email address.

3. The management apparatus according to claim 1,
wherein:
the email address received by the receiving section includes a plurality of email addresses associated with the content;
the save state determining section determines whether the content has already been saved, in accordance with an instruction from a communication terminal of at least one of users corresponding to the email addresses, in the user dedicated storage area; and
in a case where the save state determining section has determined that the content has already been saved, in accordance with the instruction, in the storage area dedicated to the at least one user, the transmitting section does not transmit the email to any of the email addresses.

4. The management apparatus according to claim 1,
wherein:
the email address received by the receiving section includes a plurality of email addresses associated with the content;
the save state determining section determines, for each of communication terminals of users corresponding to the email addresses, whether the content has already been saved, in accordance with respective instructions from the communication terminals, in the user dedicated storage area; and
the transmitting section transmits the email to an email address corresponding to a communication terminal that has not yet instructed the management apparatus to save the content in the user dedicated storage area.

5. The management apparatus according to claim 1,
wherein:
the save state determining section further determines whether the content has already been saved in the user dedicated storage area in accordance with an instruction from a communication terminal other than a communication terminal corresponding to the email address; and
in a case where the save state determining section has determined that the content has already been saved in the user dedicated storage area in accordance with the instruction, the transmitting section does not transmit the email to the email address.

6. The management apparatus according to claim 1,
wherein:
the content is first content;
the receiving section receives, in addition to the first content, second content created in a same play as the first content;
the performing section temporarily saves the first content and the second content in the temporary saving section; and
in a case where the save state determining section has determined that the second content has already been saved in the user dedicated storage area, the transmitting section does not transmit the email to the email address.

7. The management apparatus according to claim 1, further comprising
a user instruction executing section for, in accordance with an instruction from an external device, saving, in the user dedicated storage area, the content temporarily saved in the temporary saving section.

8. The management apparatus according to claim 1,
wherein
the email transmitted by the transmitting section varies according to a member status of a user corresponding to the email address.

9. The management apparatus according to claim 8,
wherein
member statuses include a paid member, a free member, and a non-member.

10. The management apparatus according to claim 8,
wherein
the email transmitted by the transmitting section (i) in a case where the member status of the user is a non-member, prompts the user to become a member and (ii) in a case where the member status of the user is a free member, prompts the user to become a paid member.

11. The management apparatus according to claim 1, further comprising
a billing amount deciding section for deciding a billing amount for a user in accordance with a number of the photograph image that the user saves in the user dedicated storage area.

12. A method for controlling a management apparatus, the method comprising:
a receiving step for receiving (i) content, which is a photograph image, created by a content providing apparatus and (ii) an email address entered at the content providing apparatus and associated with the content;
a performing step for temporarily saving the content and the email address in association with each other in a temporary saving section;
a remaining save period determining step for determining whether the content in the temporary saving section has a remaining save period shorter than a predetermined period;
a save state determining step for determining whether the content has already been saved in a user dedicated storage area; and
a transmitting step for, in a case where (i) the remaining save period determining step has determined that the remaining save period of the content is shorter than the predetermined period and (ii) the save state determining step has determined that the content has not yet been saved in the user dedicated storage area, transmitting to the email address an email for notification of a save state of the content.
